(19) United States
(12) Patent Application Publication
(10) Pub. No.: US 2018/0101616 A1
(43) Pub. Date: Apr. 12, 2018

(54) Search System, Page Display Method and Client Terminal

(71) Applicant: Alibaba Group Holding Limited, Grand Cayman (KY)

(72) Inventor: Jing Ma, Hangzhou (CN)

(21) Appl. No.: 15/727,481

(22) Filed: Oct. 6, 2017

(30) Foreign Application Priority Data
Oct. 9, 2016 (CN) 201610881987.1

(51) Int. Cl. G06F 17/30; G06Q 30/02

(52) U.S. Cl. CPC G06F 17/30867; G06F 17/30905; G06F 17/3089; G06Q 30/0282

(57) ABSTRACT

A search system, a page display method, and a client terminal are disclosed. The search system includes a front-end server used for receiving a keyword provided by a client terminal, providing the keyword to a content search engine, and returning a content result set that is obtained to the client terminal; and the content search engine used for performing a search in a content resource pool based on the keyword to obtain the content result set, and providing the content result set to the front-end server. The present disclosure can provide a diversified search result to a user, thus facilitating browsing of the user and improving user experience.

### CROSS REFERENCE TO RELATED PATENT APPLICATION

This application claims foreign priority to Chinese Patent Application No. 201610881987.1 filed on Oct. 9, 2016, entitled “Search System, Page Display Method and Client Terminal”, which is hereby incorporated by reference in its entirety.

### TECHNICAL FIELD

The present disclosure relates to the field of computer technologies, and particularly, to search systems, page display methods and client terminals.

### BACKGROUND

Along with the continuous development of electronic commerce, more and more consumers are becoming comfortable to conduct shopping online and enjoy the convenience brought forth by online shopping.

As various kinds of factors in electronic commerce platform continuously increase, a single page entry has gradually failed to satisfy the needs of consumers. For example, shopping websites, such as Taobao, JD.com, Amazon, etc., have a tremendous number of products. A consumer will perform tedious operations in order to browse products that they desire to buy if relying on page navigation only.

Therefore, search engines are set up in a shopping platform to provide product search functions to consumers. A search engine is a system that searches information from the Internet using a specific computer program according to a defined strategy, provides a search function to a user and displays related information of the user's searches after organizing and processing the information. The function implemented thereby is generally referred to as pre-processing data, creating indices, accepting a search request, and returning a result. Pre-processing data refers to converting data obtained from various types of sources into structured data according to requirements of the search engine. Creating indices refers to creating related indices based on various types of segments in the structured data. Accepting a search request and returning a result refer to performing a search in the created indices using a search keyword, and returning structured data that is pointed to by a found index.

A consumer may use a search function of a shopping platform, and directly input a name of a product that is desired to buy. As such, the name of the product can be used as a keyword. Searching and matching products in the shopping platform are performed, and a list obtained from the search is displayed.

However, search functions provided by existing shopping platforms are relatively simple, and only provide product lists for keywords provided by consumers. This hardly satisfies the increasingly diversified needs of the consumers.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The goals of the embodiments of the present disclosure are to provide a search system, a page display method and a client terminal, which can provide diversified search results to a user.

In order to achieve the above goals, the embodiments of the present disclosure provide a search system, which includes a front-end server and a content search engine. The front-end server is used for receiving a keyword provided by a client terminal, providing the keyword to the content search engine, and returning a content result set that is obtained to the client terminal. The content search engine is used for performing a search in a content resource pool based on the keyword to obtain the content result set, and providing the content result set to the front-end server. The content resource pool includes at least one of respective topic information of objects or respective aggregate information of the objects. The content result set includes topic information or aggregate information that matches the keyword. Alternatively, the content result set includes the topic information and the aggregate information that matches the keyword.

The embodiments of the present disclosure further provide a search system, which includes a front-end server, a content search engine and an object search engine. The front-end server is used for receiving a keyword provided by a client terminal, providing the keyword to the content search engine and the object search engine, and returning a content result set and an object result set that are obtained to the client terminal. The content search engine is used for performing a search in a content resource pool based on the keyword to obtain the content result set, and providing the content result set to the front-end server. The content resource pool includes at least one of respective topic information of objects or respective aggregate information of the objects. The content result set includes topic information or aggregate information that matches the keyword. Alternatively, the content result set includes the topic information and the aggregate information that matches the keyword. The object search engine is used for performing a search in an object resource pool to obtain the object result set, and providing the object result set to the front-end server. The object resource pool includes information of at least one object.

The embodiments of the present disclosure further provide a search system, which includes a front-end server, a collaborative search engine and an object search engine. The front-end server is used for receiving a keyword provided by a client terminal, providing the keyword to the collaborative search engine and the object search engine, and returning a collaborative result set and an object result set that are obtained to the client terminal. The collaborative search engine is used for obtaining access data of the client terminal, performing a search in the access data using the keyword to obtain the collaborative result set, and providing the collaborative result set to the front-end server. The collaborative result set includes object information matching the keyword in the access data. The object search engine is used for performing a search in an object resource pool to obtain the object result set, and providing the object result set to the front-end server. The object resource pool includes information of at least one object.

The embodiments of the present disclosure further provide a page display method, which includes displaying a search page, the search page including a keyword input field; receiving a keyword in the input field that is inputted by a user; displaying prompt information, the prompt information being generated based on the keyword; and displaying a search result of the keyword in response to an occurrence of a triggering event directed to the prompt information.

The embodiments of the present disclosure further provide a client terminal, which includes a display; a processing device used for controlling the display to present a search page, the search page including a keyword input field, receiving a keyword inputted by a user in the input field; controlling the display to present prompt information, the prompt information being generated based on the keyword, and to present a search result of the keyword in response to an occurrence of a triggering event directed to the prompt information.

As can be seen from technical solutions provided by the embodiments of the present disclosure above, the embodiments of the present disclosure provide a content search engine, a collaborative search engine, and an object search engine. Using any combinations of the above search engines, a diversity of search strategies can be achieved and conducted for a keyword provided by a client terminal, and information having multiple dimensions can be provided to a user. The user can obtain an entry for topic information, an entry for aggregate information such as promotion, an entry for a collaborative result set related to a browsing history or a favorite history, and a product information list, in a page. Therefore, operations of the user are simplified, and the user can understand information related to the keyword in a comprehensive manner, thus providing convenience to the user and improving user experience.

### BRIEF DESCRIPTION OF THE DRAWINGS

In order to understand the embodiments of the present disclosure or technical solutions for existing technologies in a better manner, drawings that are needed in the descriptions of the embodiments or the existing technologies are briefly described herein. Apparently, the accompanying drawings described herein merely represent some embodiments as described in the present disclosure. Based on these accompanying drawings, one of ordinary skill in the art can also obtain other drawings without making any creative effort.

FIG. 1 shows a schematic diagram of modules of a search system provided according to the embodiments of the present disclosure.

FIG. 2 shows a flowchart of operations of a search system provided according to the embodiments of the present disclosure.

FIG. 3 shows a schematic diagram of an interface of a client terminal provided according to the embodiments of the present disclosure.

FIG. 4 shows a schematic diagram of an interface of a client terminal provided according to the embodiments of the present disclosure.

FIG. 5 shows a schematic diagram of an interface of a client terminal provided according to the embodiments of the present disclosure.

FIG. 6 shows a schematic diagram of an interface of a client terminal provided according to the embodiments of the present disclosure.

FIG. 7 shows a flowchart of a method of generating an object resource pool provided according to the embodiments of the present disclosure.

FIG. 8 shows a flowchart of a method of displaying a page provided according to the embodiments of the present disclosure.

FIG. 9 shows an interface of a client terminal provided according to the embodiments of the present disclosure.

FIG. 10 shows an interface of a client terminal provided according to the embodiments of the present disclosure.

FIG. 11 shows a schematic diagram of a structure of a client terminal provided according to the embodiments of the present disclosure.

FIG. 12 shows a schematic diagram of a client terminal provided according to the embodiments of the present disclosure.

FIG. 13 shows a schematic diagram of a client terminal provided according to the embodiments of the present disclosure.

FIG. 14 shows a schematic diagram of a client terminal provided according to the embodiments of the present disclosure.

### DETAILED DESCRIPTION

In order to facilitate one skilled in the art to understand the technical solutions of the present disclosure in a better manner, the technical solutions in the embodiments of the present disclosure are described clearly and comprehensively herein in conjunction with the accompanying drawings. Apparently, the described embodiments merely represent a portion and not all of the embodiments of the present disclosure. Based on the embodiments in the present disclosure, other embodiments that are obtained by one of ordinary skill in the art without making any creative effort shall fall in the scope of protection of the present disclosure.

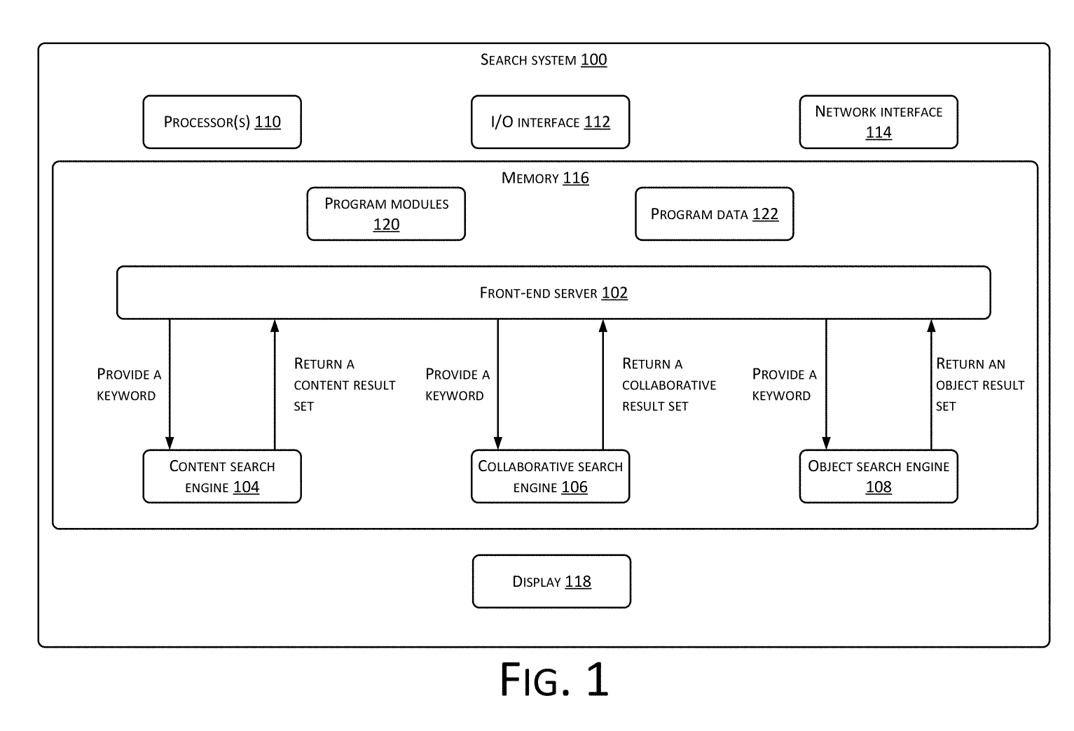

Referring to FIG. 1, the embodiments of the present disclosure provides a search system 100. The search system 100 includes a front-end server 102, and a content search engine 104. In implementations, the search system 100 may include one or more computing devices. Alternatively, the search system 100 may be a part of a computing device. By way of example and not limitation, the search system 100 may include one or more processors 110, an input/output (I/O) interface 112, a network interface 114, and memory 116. In some implementations, the search system 100 may further include a display 118.

The memory 116 may include a form of computer readable media such as a volatile memory, a random access memory (RAM) and/or a non-volatile memory, for example, a read-only memory (ROM) or a flash RAM. The memory 116 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 116 may include program modules 120 and program data 122.

The front-end server 102 is used for receiving a keyword provided by a client terminal, providing the keyword to the content search engine, and returning a content result set to the client terminal.

In implementations, the front-end server 102 may be an electronic device having computing and network interaction functions, or software running in the electronic device and providing support for data processing and network interactions.

In implementations, no limit about the number of servers is imposed for the front-end server 102. The front-end server 102 may a single server, a plurality of servers, or a server cluster formed by multiple servers.

In implementations, the front-end server 102 may be a business server of an electronic commerce website server. As such, a client terminal can directly conduct communications with the front-end server 102 via a network, and send a keyword to the front-end server 102. Accordingly, the front-end server 102 may directly send a search result set that is obtained to the client terminal. Apparently, the front-end server 102 may be an intermediary server deployed between business server(s) and search engine(s). In this case, the intermediary server may act as a channel for interactions between the business server(s) and the search engine(s). The intermediary server may correspond to multiple servers, coordinate search requests of business servers to various search engines, and return search result sets returned by the search engines to corresponding business servers.

In implementations, the client terminal may be an electronic device having display, computing and network access functions. Specifically, the client terminal may be a computer, a tablet computer, a notebook computer, a smart-phone, a digital assistant, a smart wearable device, a shopping guide device, a television having a network access function. Alternatively, the client terminal may be software running in an electronic device as described above. Specifically, the client terminal may be an access entry provided by a shopping website platform, such as Dangdang website, JD.com website, Amazon website, etc. The client terminal may be an application running in a smart-phone provided by a shopping website platform, such as mobile Dangdang, mobile JD.com, Amazon Mobile, etc.

In implementations, the keyword may be information inputted by a user in the client terminal, which is used for searching content that the user wants to browse. A keyword may be a character string having a certain semantic meaning. The number of keyword can be one or more. Specifically, the user wants to buy a luggage, and can input a keyword “luggage” in the client terminal. The user may have an additional request. For example, the user may desire to buy a luggage that is in a relatively business style. In this case, a keyword inputted by the user may include “luggage” and “business”.

In implementations, the keyword provided by the client terminal may be received via the Internet. Specifically, the client may send an access request to the front-end server 102 according a network communication protocol, such as HTTP, TP/IP or FTP protocol, etc. The keyword may be included in the access request. As such, the front-end server 102 may perform corresponding response processing after receiving the keyword.

In implementations, the front-end server 102 provides the keyword to the content search engine 104. As such, the content search engine can perform a search based on the keyword. In other words, the content search engine can respond to the keyword designated by the user, perform a search, and thereby implement a return of a search result to the user.

In implementations, the search result set received by front-end server 102 from the search engine may form a search result list. Display template(s) may be preset in the front-end server 102. Elements in the search result list are distributed and allocated in the display template(s). An element may correspond to a single display template. Alternatively, a plurality of elements may correspond to a single display template. The front-end server 102 may send the search result list that has matched and allocated with the display template to the client terminal that provides the keyword.

The content search engine 104 is used for performing a search in a content resource pool based on the keyword to obtain the content result set, and providing the content result set to the front-end server 102. The content resource pool includes at least one of topic information of an object or aggregate information of the object. The content result set includes topic information or aggregate information that matches the keyword. Alternatively, the content result set includes topic information and aggregate information that matches the keyword.

In implementations, the content resource pool may include all data information in a website platform. The content resource pool may alternatively include a portion of all the data information in the website platform. The content resource pool may be obtained by filtering and necessary data processing of data information in the website platform according to preconfigured processing rule(s). Specifically, for the promotion of same products in a website platform, aggregate information about the promotion of the products may be obtained by aggregation. Examples of the website platform include JD.com, Amazon, Dangdang, eBay, etc. The object may be a product or service provided by the website platform. The content resource pool may further include topic information of object(s). Content referred by the topic information may include shopping guide information and description information of the object(s). The topic information may further point to a topic page uploaded and designed by a merchant thereof in the website platform. The topic information may include description information of the object(s) and corresponding object list(s).

Apparently, the content of the content resource pool is not limited to what is obtained in the website platform. A content source of the content resource pool may further be provided by a third party. It can be understood that the third party may collect and organize data information in a network to form the content resource pool. The third party may provide the content resource pool to the website platform for storage. The third party may also provide an access entry to the website platform, and may provide an index list to the website platform. As such, the content search engine may perform searching and matching based on the index list, and may further retrieve result data from the content resource pool of the third party based on the index list. The third party may be a company specialized for data organization, a professional electronic product evaluation website, or a merchant in the website platform.

The topic information in the content resource pool may be a page itself. The topic information may also be a pointer mark of a page. A page can be determined through the topic information. Correspondingly, the aggregate information may point to an aggregate page that is formed by aggregation. The aggregate page includes object information obtained from aggregation. The aggregate information may be a pointer mark of the aggregate page. A corresponding aggregate page can be determined through aggregate information. Therefore, the content resource pool does not need to store pages, thus saving storage spaces.

In implementations, an algorithm of generating aggregate information from object information in a website platform may include a partitioning algorithm, a hierarchical method, a model algorithm, etc. Specifically, a partitioning algorithm may include, for example, a K-means algorithm, a K-medoids algorithm, a Clarans algorithm. A hierarchical method may include a Birch algorithm, a Cure algorithm, a Chameleon algorithm, etc. A model-based algorithm may include a neural network, etc. Apparently, the present disclosure is not limited to the above algorithms. Other algorithms can also be used by one skilled in the art based on the insights in the technical essence of the present disclosure, and are covered by the scope of protection of the present disclosure, as long as respective functions and effects that are achieved are identical or similar to those of the present disclosure.

In implementations, the content search engine 104 may create indices for the topic information and the aggregate information in the content resource pool. Therefore, when performing a search operation, a keyword may be matched from an index list to obtain a content result set. Specifically, the topic information and the aggregate information in the content resource pool may possess attribute tags respectively, for example. The content of each attribute tag may represent feature(s) of respective topic information and aggregate information. Specifically, topic information related to “cup” possesses attribute tags of “304 steel” and “thermal insulation”, and can represent that a portion of content included in the topic information related to the “cup” describes the material of the cup to be 304 steel, and a portion of content of the topic information describes the cup having a function of thermal insulation. Similarly, aggregate information related to “cup” possesses attribute tags of “plastic” and “wide-mouth”, and can represent that a portion of object information in the aggregate information points to the material of the cup as plastic, and a portion of the object information in the aggregate information points to the mouth of the cup as wide-mouth. When creating the indices, the attribute tags of the topic information and the aggregate information can be used as sources of content of the indices. All the attribute tags of the topic information or the aggregate information can be used as a portion of corresponding indices. Alternatively, some of the attribute tags of the topic information or the aggregate information can be selected as the content of the indices. Apparently, sources of content of indices are not limited to attribute tags, and may include a title of topic information, or a topic, description information, etc., of object information in aggregate information. Apparently, one skilled in the art may have a number of methods about how to conduct a search based on a content resource pool. Accordingly, one skilled in the art can also perform modifications to search methods in existing technologies based on the insights in the technical essence of the present disclosure. However, as long as functions and effects implemented thereby are identical or similar to those of the present disclosure, they are covered by the scope of protection of the present disclosure.

In implementations, the content search engine 104 sends the content result set to the front-end server 102, so that the front-end server 102 may provide the content result set to the client terminal that provides the keyword. Specifically, the content search engine 104 may rank data in the content result set and provide thereof to the front-end server 102. Apparently, the front-end server 102 may perform ranking of the data in the content result set after receiving the content result set.

In implementations, the search system may further include a collaborative search engine 106. The collaborative search engine 106 is used for obtaining access data of the client terminal, performing a search in the access data to obtain a collaborative result set, and returning the collaborative result set to the front-end server 102. The collaborative result set includes object information matching the keyword in the access data. Correspondingly, the front-end server 102 is further used for providing the keyword to the collaborative search engine 106, and providing the collaborative result set that is obtained to the client terminal.

In implementations, the access data may include records of all or part of operations of the user in the website platform, and specifically include, for example, object pages browsed and accessed by the client terminal, object pages that are set as favorites by the client terminal, topic pages browsed by the client terminal, etc.

In implementations, the access data may be records of business servers that the client terminal interacts with. In implementations, a business server may record information according to a request for access data from the collaborative search engine 106. Alternatively, in other implementations, the access data may be log data that a business server records for the client terminal. As such, after the front-end server 102 receives the keyword from the client terminal, the collaborative search engine 106 may inform the business server and provide the access data of the client terminal. Therefore, the collaborative search engine 106 may analyze the access data to obtain the collaborative result set.

In implementations, the method of obtaining the access data by the collaborative search engine 106 may include locally reading the access data of the client terminal by the front-end server 102 after the front-end server 102 receives the keyword, and providing the access data to the collaborative search engine 106 by the front-end server 102 when the keyword is provided to the collaborative search engine 106 by the front-end server 102. Alternatively, the business server may provide the access data of the client terminal to the front-end server 102 after the front-end server 102 receives the keyword, and the front-end server 102 provides the keyword and the access data to the collaborative search engine 106 at the same time. Alternatively, the collaborative search engine 106 may send a request for obtaining access data to the business server after receiving the keyword, and the business server provides the access data. Alternatively, the collaborative search engine 106 may internally store access data sets of client terminals in the website platform, and perform a search in the locally stored access data sets to obtain the access data corresponding to the client terminal after receiving the keyword. The access data in the collaborative search engine 106 can be obtained from the front-end server 102 or the business server on a regular basis. Alternatively, a synchronization rule may be created for the access data in the collaborative search engine 106 and the access data in the front-end server 102 or the business server. When a change occurs in the access data in the front-end server 102 or the business server, the access data in the collaborative search engine 106 is updated accordingly.

In implementations, the collaborative search engine 106 performs a search in the access data using the keyword. The collaborative search engine 106 may process the access data according to predefined index creation rule(s), and create indices for object information in the access data. Therefore, when performing a search, matching of a keyword may be performed in the indices to obtain a collaborative result set. Apparently, the collaborative search engine 106 may directly match the keyword in the access data, and put corresponding object information that matches the keyword into a collaborative result set. Specifically, a user browses a product page of a first dress using a client terminal, with a title name as “2016 New Lace Dress”, and save a second dress as a favorite, with a title name as “Red Silk Business-style Dress”. In this case, a business server records page browsing information of the client terminal and favorite information of the product into log data of the client terminal. Specifically, the log data may record web addresses of products, titles of the products, access activities of the client terminal with respect to product pages. The access activities may be browsed or collected. Apparently, a favorite list may be separately set up for activities of setting products as favorites by a client terminal. The favorite list may also be used as at least one portion of access data. When a user sends a keyword of “dress” to the front-end server 102 via a client terminal, a business server provides the keyword and access data of the client terminal to the front-end server 102. After receiving the keyword and the access data, the front-end server 102 provides the keyword and the access data to the collaborative search engine 106. The collaborative search engine 106 matches the keyword in the access data, and finds that the keyword of “dress” exists in the title of the first dress in the access data. Therefore, information of the first dress is added into a collaborative result set. The keyword of “dress” is also found in the title of the second dress in the access data, and information of the second dress is also added into the collaborative result set.

Object information may include an object identifier of an object. The object identifier may uniquely identify the object in the website platform. Accordingly, the collaborative result set include object identifiers of objects, and can thus uniquely determine corresponding objects. An object identifier may be a character string assigned by the website platform. Apparently, an object identifier may also be an access address of a page of an object. The client terminal can display corresponding description information of the object by accessing the access address. Specifically, detailed description information of a product may be presented and a purchase function of the product may be provided when an access address of the product in a website platform of “JD.com” is accessed, for example. Apparently, object information is not limited to what is described above. Object information may also include a topic of an object, description information, a representative picture, etc.

It can be understood that one skilled in the art can have a number of searching and matching strategies for the collaborative search engine 106 with regard to searching a keyword in access data to obtain a collaborative result set. Furthermore, one skilled in the art can also perform modifications to existing technologies based on the insights in the technical essence of the present disclosure. However, as long as functions and effects achieved thereby are identical or similar to those of the present disclosure, they are also covered by the scope of protection of the present disclosure.

In implementations, the collaborative search engine 106 sends the collaborative result set that is obtained to the front-end server 102, so that the front-end server 102 can provide the collaborative result set to the client terminal from which the keyword is provided. Specifically, the collaborative search engine 106 can provide the collaborative result set to the front-end server 102 after performing ranking thereof. Apparently, the front-end server 102 can perform ranking of the data in the collaborative result set after receiving the collaborative result set.

In implementations, the search engine may further include an object search engine 108. The object search engine 108 is used for performing a search in an object resource pool based on the keyword to obtain an object result set, and providing the object result set to the front-end server 102. The object resource pool includes at least object information. Correspondingly, the front-end server 102 is further used for providing the keyword to the object search engine 108, and providing the object result set that is obtained to the client terminal.

In implementations, the object resource pool may include information of all objects in the website platform. Accordingly, the object search engine 108 can obtain a relatively comprehensive search result with respect to the keyword for the user to browse by performing a search in the object resource pool using the keyword. Apparently, the object resource pool can also be formed from a selection of all of the objects in the website platform according to predetermined selection criteria. In this way, each time when the object search engine 108 performs a search, the workload thereof can be reduced, and the storage space occupied by the object resource pool can be decreased. Specifically, Amazon website, as a website platform, provides a number of products and services, for example. An object resource pool can be constructed from information of all of the products and the services in the Amazon website. Apparently, the object resource pool may be obtained through selection and filtering of different types and categories of products and services in the Amazon website. Specifically, selection and filtering criteria may include evaluations from consumers, sales volumes, browsing volumes, numbers of collection as favorites, etc., and are not tediously described herein.

In implementations, the object search engine 108 may create indices for the object information in the object resource pool. As such, when a search operation is performed, a keyword can be matched in an index list to obtain an object result set. Apparently, one skilled in the art may have a number of methods about how to conduct a search based on an object resource pool. Accordingly, one skilled in the art can also perform modifications to search methods in existing technologies based on the insights in the technical essence of the present disclosure. However, as long as functions and effects implemented thereby are identical or similar to those of the present disclosure, they are covered by the scope of protection of the present disclosure.

In implementations, the object search engine 108 sends the object result set that is obtained to the front-end server 102, so that the front-end server 102 can provide the object result set to the client terminal that provides the keyword. Specifically, the object search engine 108 can provide the object result set to the front-end server 102 after ranking data in the object result set. Apparently, the front-end server 102 may rank the data in the object result set after receiving the object result set.

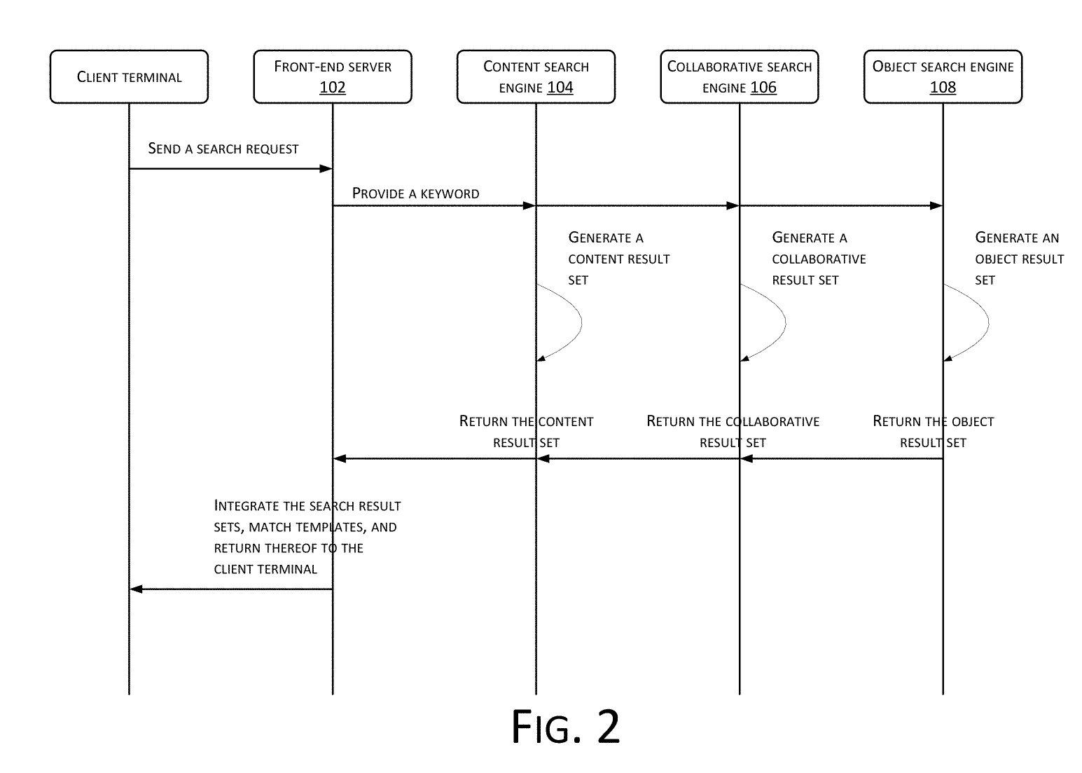

In a particular exemplary scenario, a search system 100 may include the front-end server 102, the content search engine 104, the collaborative search engine 106, and the object search engine 108, as shown in FIG. 1 and FIG. 2. The front-end server 102 may be one or more business server(s). A content resource pool of the content search engine 104 includes topic information and aggregate information. The collaborative search engine 106 includes access data of website platform(s) and client terminal(s). The object search engine 108 includes an object resource pool that is obtained by filtering and selection of information of objects in the website platform.

In the present exemplary scenario, the front-end server 102 receives a search request sent from a client terminal. The search request includes a keyword of “Lenovo laptop computer”. The front-end server 102 separately provides the keyword of “Lenovo laptop computer” to the content search engine 104, the collaborative search engine 106, and the object search engine 108. The front-end server 102 further provides identity information associated with the client terminal to the collaborative search engine 106, to allow the collaborative search engine 106 to read access information corresponding to the client terminal from an access information set stored therein based on the identity information associated with the client terminal. The identity information associated with the client terminal may include a web address, a username, etc., that is/are associated with the client terminal.

In the present exemplary scenario, the content search engine 104 searches the content resource pool using the keyword to obtain a content result set. The content result set includes topic information and aggregate information that is related to “Lenovo laptop computer”. The topic information may include “performance evaluation of Lenovo laptop computer”, “description of models of Lenovo laptop computer”, “detailed topic list of high performance-to-price ratio of Lenovo laptop computer”, etc. The aggregate information may include promotion information related to Lenovo laptop computer.

In the present exemplary scenario, the collaborative search engine 106 performs a search for the received information associated with the client terminal in the stored access data set to obtain access data corresponding to the information associated with the client terminal. The access data may include information of pages previously browsed by the client terminal and information of pages previously set as favorites by the client terminal. Object information corresponding to page browsing information and page favorite information that is found to be related to “Lenovo laptop computer” is added into a collaborative result set. The collaborative result set is sent to the front-end server 102.

In the present exemplary scenario, the object search engine 108 performs a search for “Lenovo laptop computer” in an object resource pool, and obtains an object result set that matches “Lenovo laptop computer”. The object result set is sent to the front-end server 102.

In implementations, after receiving the content result set, the collaborative result set and the object result set, the front-end server 102 generates a search result list that is to be returned to the client, and matches each element in the result list to a respective display template. Ordering in the list is: the content result set having priority to the object result set and the collaborative result set having a designated position in the search result list. The front-end server 102 returns the search result set matching display template(s) to the client terminal, to enable the client terminal to provide a presentation of a page. However, one skilled in the art should understand that an ordering of the foregoing content result set, collaborative result set and object result set can be freely defined according to an actual condition, and is not limited to the ordering of the above embodiment.

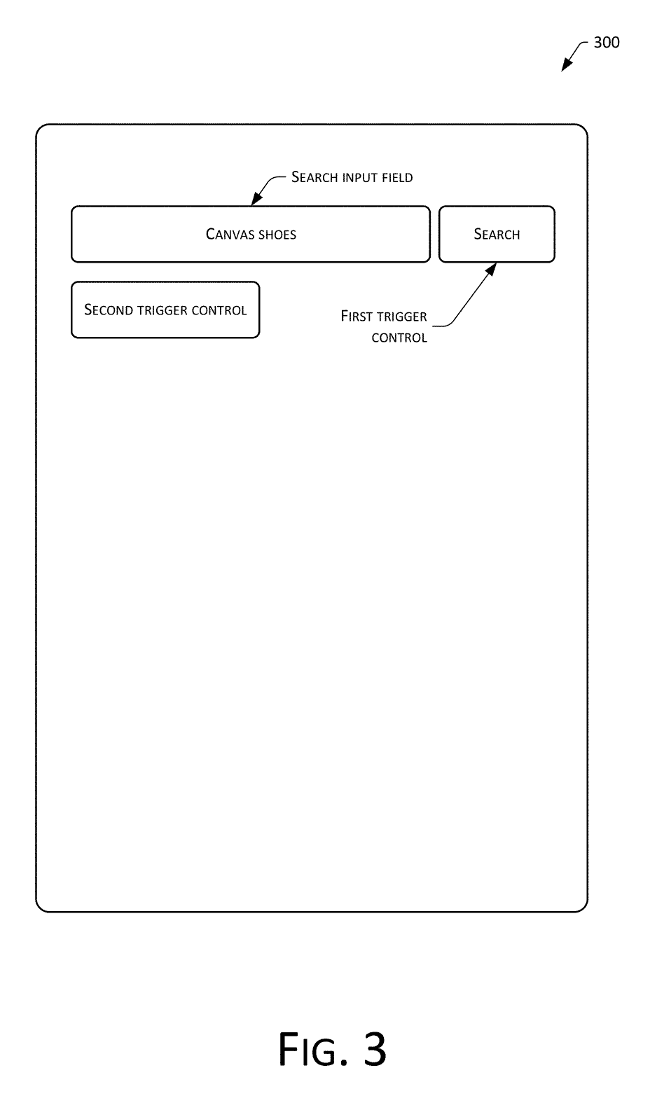

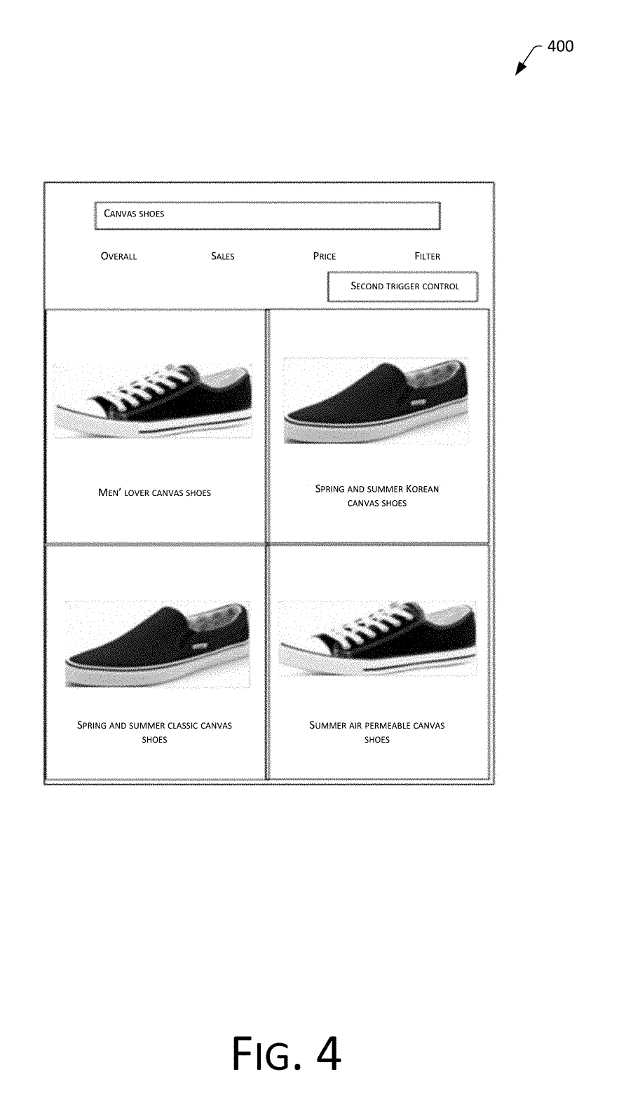

In another exemplary scenario as shown in FIG. 3, a user opens a search page 300 via a client terminal. The search page 300 has a search input field and a first trigger control. Referring to FIG. 3, the user inputs “canvas shoes” in the search input field, and clicks on the first trigger control. In response to detecting a clicking event of the first trigger control, the client terminal sends the keyword “canvas shoes” to a server, and received a search result returned by the server. As shown in FIG. 4, the client terminal presents a result display page 400. Search results can be presented in a form of a list of images and texts in the page 400. A process of such searching can be a search by the server through an invocation of an object search engine, or other methods for searching products or services.

In the present exemplary scenario, a second trigger control may be provided in the page 300 as shown in FIG. 3. The second trigger control may also be provided in the result display page 400 as shown in FIG. 4. The user triggers the second trigger control, and the client terminal provides the keyword of “canvas shoes” to the front-end server as described in the foregoing embodiment. The front-end server can provide the keyword of “canvas shoes” to the content search engine, the collaborative search engine and the object search engine. The front-end server sends a content result set, a collaborative result set and an object result set that are returned by the engines as a search result set as a whole to the client terminal. The front-end server can also match elements in the search result set with display templates, and provide information of corresponding display templates of the elements in the search result set to the client terminal.

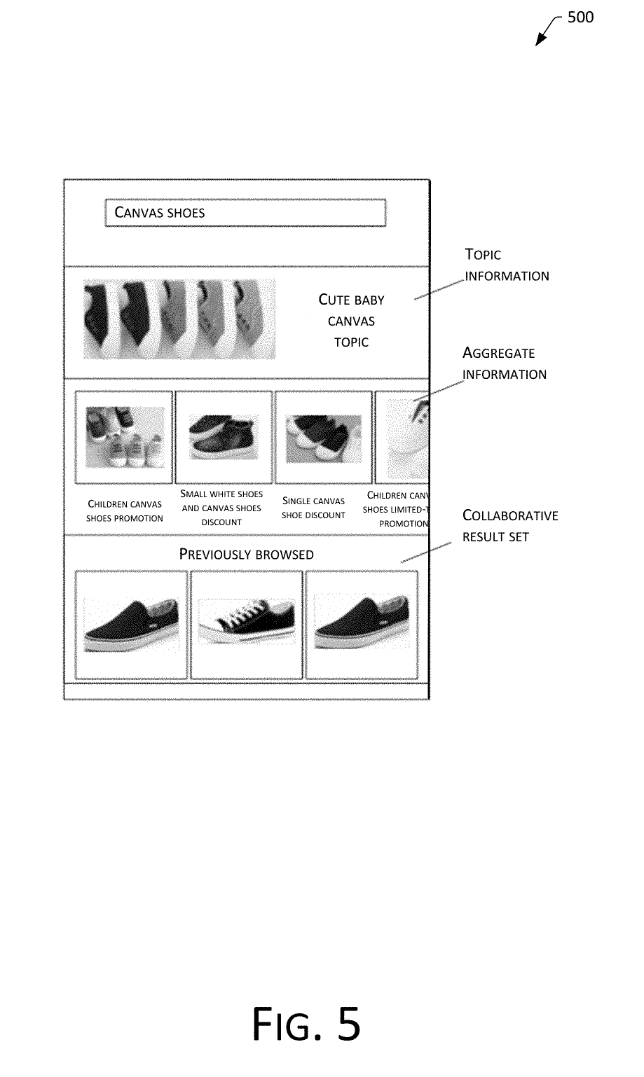

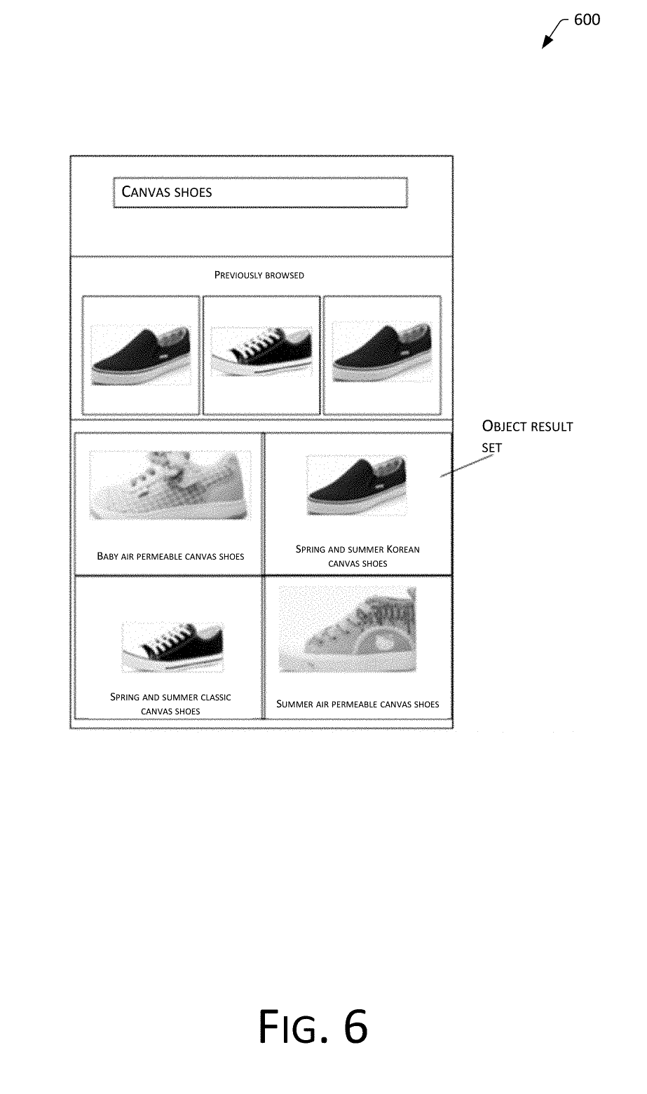

In the present exemplary scenario, a search result for “canvas shoes” that is presented by the client terminal is shown in FIG. 5. A page 500 may include promotion information pointed by topic information and aggregate information in the content result set. Furthermore, pieces of the collaborative result set are presented at “previously browsed” display positions. The user can move the page upwards and downwards. For example, a page 600 as shown in FIG. 6 is obtained by moving upwards. Object information in the object result set can be presented in a form of a list of images and texts.

In implementations, when returning the collaborative result set to the client terminal, the front-end server 102 divides the collaborative result set into at least one collaborative result subset, and assigns the collaborative result subset to a display position in the client terminal.

In implementations, the front-end server 102 may divide a collaborative result set into subsets. Each subset may include information of a designated number of objects. The designated number may be 5, 6, 9, 12, 13, etc. Furthermore, an upper bound for the number of collaborative result subsets returned to a client terminal may be set. When a total number of collaborative result sets exceeds this upper bound, a portion of the collaborative result sets is selected, such that the number of the selected collaborative result sets does not exceed the upper bound. When the total number of the collaborative result subsets does not exceed the upper bound, the front-end server 102 can return the collaborative result subset according to an actual condition.

Apparently, the collaborative search engine 106 may have finished the division into the collaborative result subsets when the collaborative result set is returned. An upper bound for the number of collaborative result subsets may be set up in the collaborative search engine 106. In this case, the number of collaborative result subsets returned by the collaborative search engine 106 complies with this upper bound.

In implementations, each collaborative result subset may correspond to a display template. A page displayed by the client terminal includes a search result set that has been applied with display template(s) to form a display list. The display list may include display items. Each display item may include data in the search result set and a corresponding display template. The collaborative result subsets can have designated positions in the display list. Specifically, the ninth position in the result set, for example, is set as a display position of a collaborative result subset. Apparently, designated positions may also be the first, the second, the fifth, the fifteenth, etc. Apparently, a random number may also be generated using a predetermined random function, and used as a display position of a collaborative result subset.

In implementations, when the front-end server 102 returns the content result set and the collaborative result set to the client terminal, the content result set has a higher priority than the collaborative result set.

In implementations, the front-end server 102 can perform an ordering of the search result set that is returned to the client terminal. Content of the content result set has a higher priority than content of the collaborative result set. As such, the content of the content result set can be browsed by the user with a relatively higher preference. Since the content result set may include topic information of objects, preferentially presenting the content result set facilitates a deeper understanding of the object by the user.

In implementations, a page pointed by the topic information may include a description page of performance of an object, a shopping guide page of the object, an evaluation page of the object, a detailed page including description information of the object.

In implementations, topic information pointing to a page may be understood as the topic information being a pointer mark of the page. A corresponding web page can be determined through topic information. The content resource pool stores topic information and does not need to store respective pages pointed by the topic information. As such, the storage space occupied thereby can be reduced, and workload caused by updating the content resource pool can be reduced. Specifically, the topic information may be an access address of a respective page.

In implementations, content of the page pointed by the topic information includes text(s), image(s), audio, video, or any combination of the above. A description page of performance of an object may include content described by a merchant with respect to performance and structure of a product or server. A shopping guide of an object may include a description of applicable scenario(s) of a product or service made by a merchant, a promoter or a media site, etc., and how to select and buy product(s) or service(s) needed by corresponding application scenario(s). An evaluation page of an object may include content about evaluation conducted by a merchant thereof, a promoter or a media site, etc., with respect to a product or service according to certain evaluation criteria after getting experience with the product or the service. A detailed page may be a list of some objects that are selected and recommended by a merchant, a promoter or a media site, etc., according to a certain topic and idea

In implementations, aggregate information pointing to an aggregate page may be a data set by collecting and obtaining information of objects having identical or similar attribute objects from a same type of objects in a website platform.

In implementations, a website platform may have a number of business modules. Each business module may provide a variety of different types of objects. Specific business modes for different business modules may be different. Specifically, a website platform of “JD.com” may include business modules, such as “JD Supermarket”, “fresh”, “worldwide purchase”, “fast purchase”, “group purchase”, for example. Different business modules may provide a same product or service. However, each business module may have its own business logic, supply channel, etc.

In implementations, objects of a same type may be products or services that are identical or similar to each other. Identical products or services may possess the same functions and effects. Objects of a same type may be objects belonging to a same product category or service category. Specifically, product categories may include, for example, televisions, computers, mouse pointers, men's tops, dresses, watches, etc, and are not exhaustively listed. Service categories may include housekeeping, repair, maintenance, dining, etc., and are not exhaustively listed.

In implementations, attributes may include an own property, a state property, etc., of an object. The own property may be a color, a structure, a shape, a function, a performance, a rating level, etc. The state property may be a current business logic state of an object, for example, a product or service being in a group purchasing activity, a product or service being on sales in a certain business, a product or service being in a normal sales, etc.

In implementations, a page presents object information that is collected, and thus facilitates a user to perform browsing and comparison, bringing convenience to the user's shopping.

In implementations, the content resource pool stores object information corresponding to the topic information or the aggregate information. The object information is used for matching a keyword provided by a client terminal, and determining whether the topic information or the aggregate information matches the keyword.

In implementations, the topic information or the aggregate information includes an object list. The object list includes information of objects. The content resource pool stores object information corresponding to the topic information or the aggregate information, which helps to return a more accurate search result when the content search engine 104 conducts a search for a keyword in the content resource pool. Specifically, information of a topic related to “Apple phone”, an index term established by the content search engine 104 may be “Iphone”+“Apple phone”, for example. Information of two objects is stored for the information of this topic. A title in information of the first object is “Iphone 6S National Work for all networks 64G”. A title in information of the second object is “Iphone 6S Telecom 64G”. If a keyword provided by a client terminal is “Iphone”, the content search engine 104 can put topic information related to “Apple phone” into a content result set by matching the keyword with information of indices. If the keyword provided by the client terminal is “Telecom Iphone”, the content search engine 104 performs a matching of the keyword in the indices, and will not put the topic information of “Apple phone” into the content result set. The content search engine 104 may further perform a matching between the keyword and object information of topic information, and detect that a match is found with the title of the information of the second object. In this case, the content search engine 104 may put the topic information of “Apple phone” into the content result set.

In implementations, each topic information or aggregate information may have a specific number of pieces of object information. Therefore, when determining whether to put corresponding topic information or aggregate information into the content result set by searching and matching in the object information, the content search engine 104 may use a relationship between a number of pieces of object information matching the keyword and the specific number as a basis for whether to put the corresponding topic information or aggregate information into the content result set. Specifically, the specific number is 100, for example. In other words, each topic information or aggregate information may individually have 100 pieces of object information that are stored. A determination condition may be set. When the number of pieces of object information matching the keyword is more than a defined ratio of the specific number, the topic information or aggregate information is put into the content result set. The ratio may be 3/4, 1/2, 1/3, etc. The determination condition may also be to put the corresponding topic information or aggregate information into the content result set when the number of pieces of object information matching the keyword reaches a conditional number. For example, the specific number is 200, and the conditional number may be 102. Apparently, the conditional number is not limited to 100, and may be 2, 5, 10, 102, 108, 200, etc. The specific number may be a positive integer.

In implementations, after a predefined time interval, aggregate information in the content resource pool is updated from the website platform to form the aggregate information.

In implementations, object information in the website platform may experience changes. Therefore, the content resource pool in the content search engine 104 updates aggregate information after a predefined time interval, and thus data in the content resource pool can be more accurate. For example, the promotion of some products or services in JD.com website usually lasts for a certain period of time, and activities associated with the promotion of these products or services will end after this period of time is past. For example, aggregate information of “mouse pointer promotion” is provided to the client terminal. After the user clicks on a window of the aggregate information corresponding to an operating page, a list of object information included in a page pointed by the aggregate information is provided, i.e., presenting a list of mouse pointers included in the aggregate page pointed by the aggregate information. As such, the user can further select a certain mouse pointer, and browse detailed information of the mouse pointer or make a purchase. Aggregate information is updated after every predefined time interval. Thus, a content result set providing to a client terminal can have more accurate product or service information. A situation, in which no discount sales or group purchase is running for a mouse pointer after the user clicks the mouse pointer to enter the detailed information of the mouse pointer, is avoided to a certain extent.

In implementations, the predefined time interval may be a time duration that is defined in advance. Specifically, the predefined time interval may be 1 day, 2 days, 5 days, 12 hours, 18 hours, or 20 hours, for example, and no limitation is imposed thereto herein.

In implementations, topic information in the content resource pool has a designated life cycle. The life cycle may be a time duration. The topic information can be browsed within the life cycle, and can no longer be provided to a client terminal after the life cycle is past. Specifically, the content resource pool can store life cycles corresponding to respective pieces of topic information. As such, a determination can be made as to whether a topic has past a life cycle thereof when topic information is searched for based on a keyword. If the life cycle is past, information of the topic will not be put into a content result set even if the information of the topic matches the keyword. Therefore, topic information having a respective life cycle being past will not be provided to a client terminal.

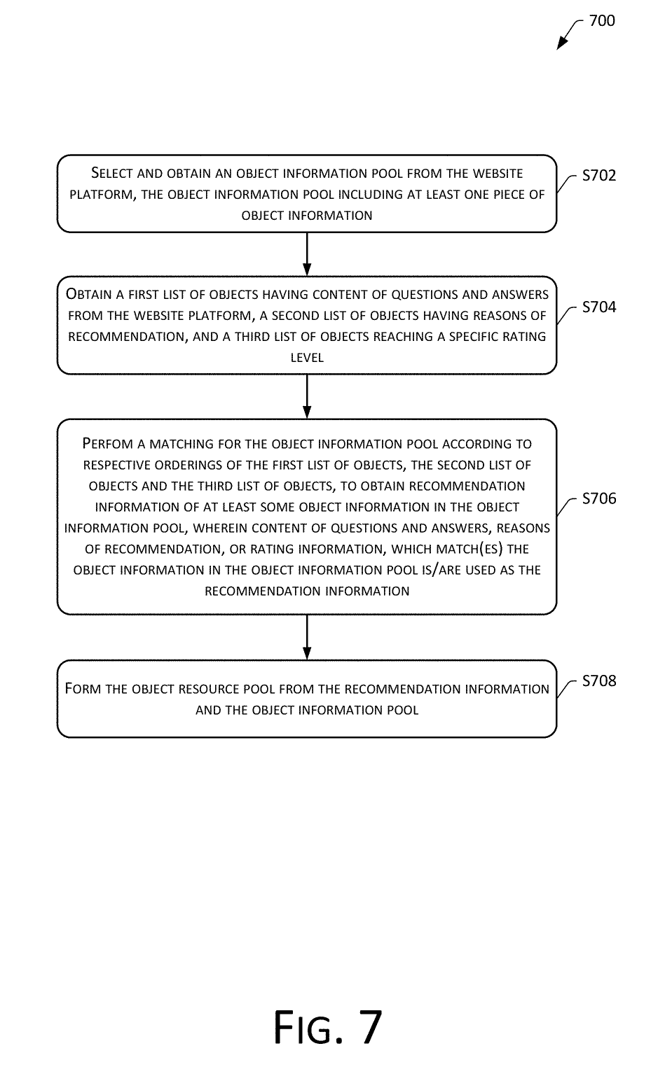

In implementations, with reference to FIG. 7, a method 700 of generating the content resource pool may include the following operations.

S702 selects and obtains an object information pool from the website platform, the object information pool including at least one piece of object information.

In implementations, an object information pool is obtaining by selecting object information in the website platform according to predetermined selection rule(s). The predetermined selection rule(s) may include reaching a specific sales volume, reaching a specific browsing volume, reaching a specific number of being set as a favorite, or reaching a specific rating level. The specific rating level may be a number of good evaluations from consumers, an evaluation score, or an evaluation star rating.

In implementations, the object information pool may be obtained by making a selection from among all object information in the website platform. Alternatively, the object information pool may be obtained by making a selection from among object information of at least one business module of the website platform. Specifically, a selection may be performed from among all the product information of the Amazon website, for example. The Amazon website may include business modules such as overseas purchases, books, household appliances, fashion galleries, electronic and digital galleries, etc. Alternatively, a selection may be made from at least one business modules of Amazon.

S704 obtains a first list of objects having content of questions and answers from the website platform, a second list of objects having reasons of recommendation, and a third list of objects reaching a specific rating level.

In implementations, the content of questions and answers may be a way of describing object information in a form of questions and answers for a particular object. Questions may be inquiries that are uploaded by users, and answers may be answers that are given by other users or answers from merchants corresponding to the objects.

In implementations, the reasons of recommendation may be generated based on a conclusion of historical sales and rating information of the object information, or textual recommendation information provided by respective promoters based on the objects. Specifically, with a lamp as an example, product evaluation and rating of the lamp may be summarized to form a reason of recommendation for the lamp.

In implementations, an object may have rating information. The rating information may be provided by a user of the object due to his/her usage experience of the object, with a designated rating for specific rating information. Specifically, the designated rating may be: an overall rating that is formed by users' ratings of the object as compared to products of a same type, with the overall rating reaching a designated level, such as 4 star rating; or a number of good comments of the object reaching a specific ratio of a total number of comments of the object; or a score given by the users reaching a specific score value.

In implementations, the first list of objects, the second list of objects and the third list of objects individually include corresponding object information. The object information may include respective object identifiers. Respective content of questions and answers, reasons of recommendation, or rating information which correspond(s) to the objects can be determined through the object identifiers.

S706 performs a matching for the object information pool according to respective orderings of the first list of objects, the second list of objects and the third list of objects, to obtain recommendation information of at least some object information in the object information pool. Content of questions and answers, reasons of recommendation, or rating information, which match(es) the object information in the object information pool is/are used as the recommendation information.

In implementations, when the object information in the object information pool is matched with the first list of objects, the second list of objects and the third list of objects, a method of determining whether respective object identifiers are the same may be used. In other words, the matching is successful if the respective object identifiers are the same. If the respective object identifiers are not the same, the matching is considered to be failed. Apparently, when the object information in the object information pool is matched with the first list of objects, the second list of objects and the third list of objects, a determination can be made as to whether an object pointed by the object information in the object information pool is the same as an object pointed by the first list of objects, the second list of objects or the third list of objects. Specifically, an object pointed by a first piece of object information in the object information pool is a pair of Nike Air shoes, for example. If the first list of objects, the second list of objects or the third list of objects has a second piece of object information pointing to an object being also a pair of Nike Air shoes and this pair of Nike Air shoes is the same as the Nike Air shoes pointed by the first piece of object information, the first piece of object information and the second piece of object information can be considered to be matched. Specifically, when determining whether objects are the same, information such as a brand, a model number, a manufacturer, etc., may be used.

In implementations, the object information in the object information pool can have corresponding matched object information in each of the first list of objects, the second list of objects and the third list of objects. Alternatively, a portion of the object information in the object information pool can have corresponding matched object information in the first list of objects, the second list of objects and the third list of objects. Under some circumstances, the object information in the object information pool may have corresponding matched object information in more than one of the first list of objects, the second list of objects and the third list of objects. In this case, respective content of questions and answers of object information that successfully matches therewith in the first list of objects is preferentially used as the recommendation information. If matching in the first list of objects fails and matching in the second list of objects is successful, a respective reason of recommendation of successfully matched object information in the second list of objects is used as the recommendation information. If matching in both the first list of objects and the second list of objects fails, corresponding rating information of successfully matched object information in the third list of objects is used as the recommendation information.

S708 forms the object resource pool from the recommendation information and the object information pool.

In implementations, the object information and corresponding recommendation information is stored correspondingly. As such, after the object information is determined, the recommendation information of the object information can be obtained.

In implementations, object information in the website platform is selected and recommendation information is correspondingly stored. As such, after providing thereof to a consuming user, the user can select better product(s) or service(s) in a more convenient manner.

In implementations, in response to receiving a search result set returned by various search engines for a keyword as null, the front-end server may return a predefined label to the client terminal, to enable the client terminal to present prompt information having a predefined semantic meaning.

In implementations, when the search system includes the content search engine, the front-end server may set the content result set as null if the search result set received from various search engines for the keyword is null. When the search system includes the content search engine and the collaborative search engine, the front-end server may set the content result set and the collaborative result set as null if the search result set received from various search engines for the keyword is null. When the search system includes the content search engine and the object search engine, the front-end server may set the content result set and the object result set as null if the search result set received from various search engines for the keyword is null. When the search system includes the content search engine, the collaborative search engine, and the object search engine, the front-end server may set the content result set, the collaborative result set, and the object result set as null if the search result set received from various search engines for the keyword is null.

In implementations, the predefined label is used for representing that the search result set is null. Therefore, the client terminal may further present prompt information. Apparently, the predefined label may be the prompt information itself. As such, after receiving the predefined label, the client terminal may directly present thereof in the page. Specifically, the keyword is an unfamiliar term or a semantic meaningless term, for example. In this case, a result returned by the search engine(s) invoked by the front-end server may be null. At that time, a predefined label returned to the client terminal may be “NULL”. After receiving this predefined label, the client terminal may present prompt information of “Mew˜No search result, no related content is found”. Alternatively, the client terminal may provide the keyword to another business search module to conduct a search, for determining whether a search result of the other business search module is null for this keyword. If the search result of the other business search module is not null, “Mew˜no related content of the current keyword is found, and other search functions may be tried if still desiring to view products!” may be presented in the page, and a link to “other search functions” is established.

In implementations, when a data amount in the search result set found for the keyword is less than a predetermined threshold, the keyword is modified, and a search is performed based on the modified keyword to obtain a new search result set.

In implementations, the data amount of results in the search result set found for the keyword being less than the predetermined threshold may include: the data amount of results in any one of the content result set, the collaborative result set and the object result set is less than the predetermined threshold; or the data amount of results in any two of the content result set, the collaborative result set and the object result set are less than the predetermined threshold; or a total data amount of results of the content result set, the collaborative result set and the object result set is less than the predetermined threshold.

In implementations, the predetermined threshold is a critical value, and can be used for determining whether the data amount of results in the search result set for the keyword is small. When the data amount of results in the content result set is counted, one piece of topic information may be treated as a unit of calculation, and one piece of aggregate information may be counted as a unit of calculation. Specifically, if the content result set includes two pieces of topic information and three pieces of aggregate information, the number of results in the content result set may be five, for example. When the data amount of results in the collaborative result set and the object result set is counted, the number of pieces of object information may be counted. Apparently, a determination may be made as to whether the data amount of results is less than the predetermined threshold directly based on the number of bytes of the search result set.

In implementations, a method of modifying the keyword may include: reducing a number of key terms provided by the client terminal to increase a data amount of results of a search result set when the number of key terms is two or more; or replacing at least one term in the keyword to allow the keyword to match a better semantic meaning. Specifically, a keyword provided by the client terminal is “rimless photo frame waterproof rounded corner”, for example. If the number of search results in a set is less than a predetermined threshold, “rimless” may be removed, and “photo frame waterproof rounded corner” is used as a keyword for performing a search. For example, a keyword provided by the client terminal is “photocamera”. “photo” can be removed to obtain “camera”, which has a better semantic meaning, as a keyword for performing a search. Alternatively, in other implementations, when a keyword provided by the client terminal has a typographical error and an inaccurate semantic meaning is resulted, the front-end server may return a modified keyword to the client terminal. As such, the client terminal can present prompt information, to remind the user of whether to use the modified keyword for performing a search.

In implementations, the front-end server extracts a specific semantic term from the keyword provided by the client terminal, and provides the semantic term to the search engine(s) for performing search(es).

In implementations, the specific semantic term may be a category term or a brand name term. The category term is used for representing a type of product or service. Specifically, the category term may include, for example, a household appliance, a book, stationery, a vehicle, a motorcycle, a t-shirt, women's fashion, a watch, etc., and is not exhaustively listed herein. The brand name term may be a name of a brand of a product or service. Specifically, the brand name term may include, for example, Nike, Joeone, Haagen-Dazs, Giant, Apple, Samsung, etc., and is not exhaustively listed. Under some circumstances, a keyword provided by the client terminal may include a category term and a brand name term at the same time. Only the category term may be used for performing a search. Alternatively, only the brand name term may be used for performing a search. Alternatively, the category term and the brand name term may be used for performing a search, while ignoring other terms.

In implementations, the specific semantic term is provided to the search engine(s) for conducting search(es). As such, a search result based only on the semantic term may be returned to the client terminal. Under some circumstances, a keyword provided by the client terminal may include multiple keywords, and may have multiple classes of terms. A semantic term may be used for conducting a search, so that the number of keywords is reduced and result data obtained by the search is increased correspondingly. Moreover, since a specific semantic term may be a category term or a brand name term, the number of terms is reduced, without leading away from a topic that the user desired to browse.

In implementations, the keyword provided by the client terminal may include multiple terms. The front-end server invokes search engine(s) for conducting search(es) using combinations of a subset of terms in the multiple terms, and returns search results of the combinations of terms to the client terminal.

In implementations, the keywords provided by the client terminal may include multiple terms. The client terminal may provide a sentence of words, and the front-end server divides this sentence of words into multiple terms. The keyword provided by the client terminal may have specific character(s) used for dividing the keyword into multiple terms. For example, a punctuation mark or a space is used. Specifically, a keyword provided by the client terminal is “2016 New Summer Women's T-shirt ONLY”, for example, which may be divided into multiple terms: “2016 New”, “Summer”, “Women's”, “T-shirt”, and “ONLY”. Alternatively, the keyword provided by the client terminal may be “2016 New, Summer, Women's, T-shirt, ONLY”, with “,” in the keyword being used as partitions among the multiple terms.

In implementations, the front-end server may perform combinations of the multiple terms, and provide the combinations of terms to the search engine(s). As such, as compared to directly sending the keyword provided by the client terminal to the search engine(s) for conducting search(es), the number of terms in each search is reduced, and the probability of obtaining more matched search results is thus increased. Specifically, term combinations formed by combining “2016 New”, “Summer”, “Women's”, “T-shirt”, and “ONLY” may include, but are not limited to, 2016 New”+“Summer”, “Women's”+“ONLY”, “2016 New”+“Summer”+“T-shirt”, “Women's”+“T-shirt”+“ONLY”, etc. Apparently, a plurality of combinations of terms may be obtained by performing permutations and combinations of the multiple terms, and the combinations of terms are sent to the search engine(s).

In implementations, search result sets obtained for different combinations of terms are organized and integrated to form a search result set, which is sent to the client terminal. Duplications of search results can be removed from the search result set. Therefore, content presented by the client terminal has a fewer number of duplications that cause a poorer browsing experience. Apparently, a search result set obtained for each combination of terms may be individually sent to the client terminal, to improve the response speed for the request of the client terminal.

Referring to FIG. 1, the embodiments of the present disclosure further provide a search system. The search system includes a front-end server 102, a content search engine 104, and an object search engine 108.

The front-end server 102 is used for receiving a keyword provided by a client terminal, providing the keyword to the content search engine 104 and the object search engine 108, and returning a content result set and an object result set to the client terminal.

The content search engine 104 is used for performing a search in a content resource pool based on the keyword to obtain the content result set, and providing the content result set to the front-end server 102. The content resource pool includes at least one of respective topic information of objects or respective aggregate information of the objects. The content result set includes topic information or aggregate information that matches the keyword. Alternatively, the content result set includes the topic information and the aggregate information that matches the keyword.

The object search engine 108 is used for performing a search in an object resource pool to obtain the object result set, and providing the object result set to the front-end server 102. The object resource pool includes information of at least one object.

Content described in implementations can be referenced and compared to the foregoing embodiments, and is not repeatedly described herein.

Referring to FIG. 1, the embodiments of the present disclosure further provide a search system. The search system includes a front-end server 102, a collaborative search engine 106, and an object search engine 108.

The front-end server 102 is used for receiving a keyword provided by a client terminal, providing the keyword to the collaborative search engine 106 and the object search engine 108, and returning a collaborative result set and an object result set that are obtained to the client terminal.

The collaborative search engine 106 is used for obtaining access data of the client terminal, performing a search in the access data using the keyword to obtain the collaborative result set, and providing the collaborative result set to the front-end server 102. The collaborative result set includes object information matching the keyword in the access data.

The object search engine 108 is used for performing a search in an object resource pool to obtain the object result set, and providing the object result set to the front-end server 102. The object resource pool includes information of at least one object.

Content described in implementations can be referenced and compared to the foregoing embodiments, and is not repeatedly described herein.

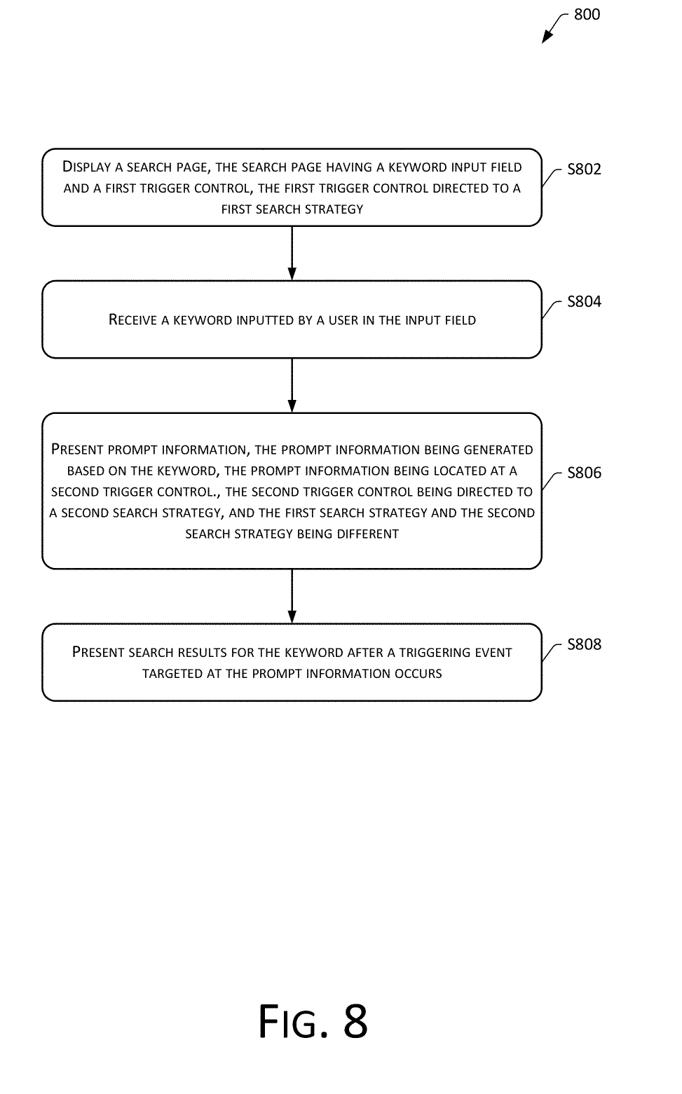

Referring to FIG. 8, the embodiments of the present disclosure further provide a page display method 800. The method 800 may include the following operations.

S802 displays a search page, the search page having a keyword input field.

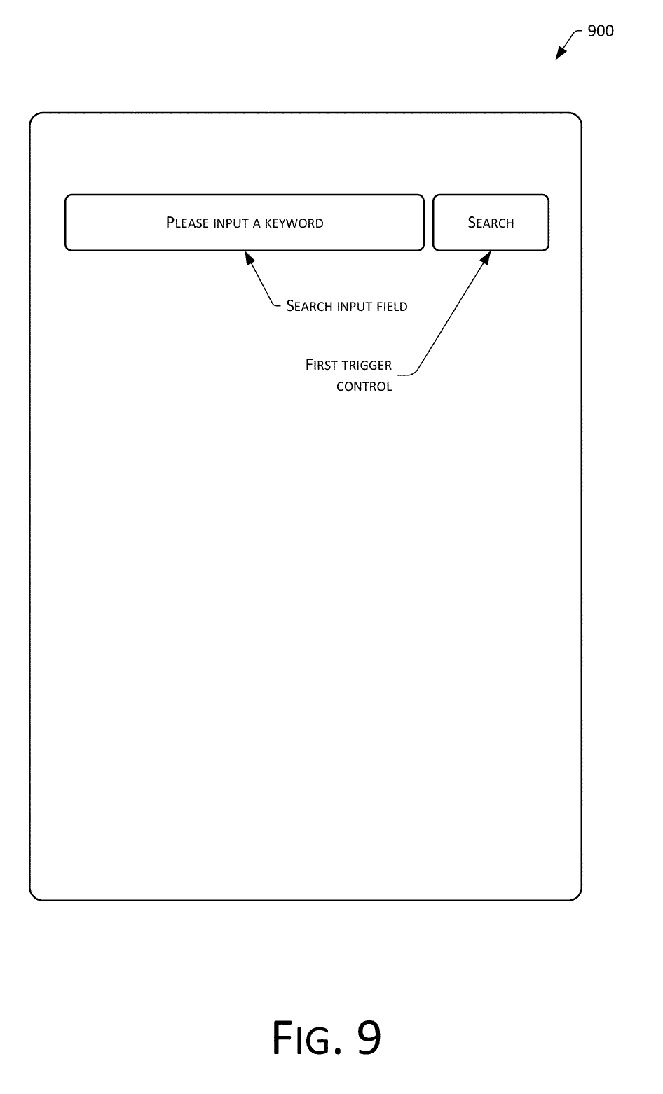

In implementations, the search page may be an operating interface 900 having a search function that is provided by a client terminal, as shown in FIG. 9. Specifically, the operating interface provides a search input field for receiving a keyword inputted by a user, for example.

S804 receives a keyword inputted by a user in the input field.

In implementations, a method of receiving the inputted keyword may include performing an input via an input method, performing an input via a voice method, and/or performing an input via an image/video capture method. Voice, image/video, or picture can be used as input information for the input field after being recognized into a text. Alternatively, a method of receiving the inputted keyword may include providing recommended term(s) on a search page, and using a recommended term corresponding to a clicking event as a keyword inputted into the input field in response to an occurrence of the clicking event with respect to the recommended term.

S806 presents prompt information, the prompt information being generated based on the keyword.

In implementations, the client terminal may have rule(s) of generating prompt information. After the keyword is inputted into the input field, prompt information is generated according to the rule(s) of generating prompt information. Specifically, the rule(s) of generating prompt information may include correspondingly storing prompt index terms and prompt terms. In response to receiving the keyword, the client terminal performs a matching of the keyword in the prompt index terms, obtains a prompt index term corresponding to the keyword, and thereby determines a prompt term corresponding to the prompt index term. Apparently, the rule(s) of generating prompt information may also include predefined categories and corresponding prompt terms. For an inputted keyword, a determination is made as to which category the keyword belongs to, and a prompt term of an associated predefined category is read. The predefined categories may include brand name terms, product categories, etc. Apparently, after receiving the keyword, the client terminal can provide the keyword to a server, and the server generates prompt information which is sent to the client terminal via a network.

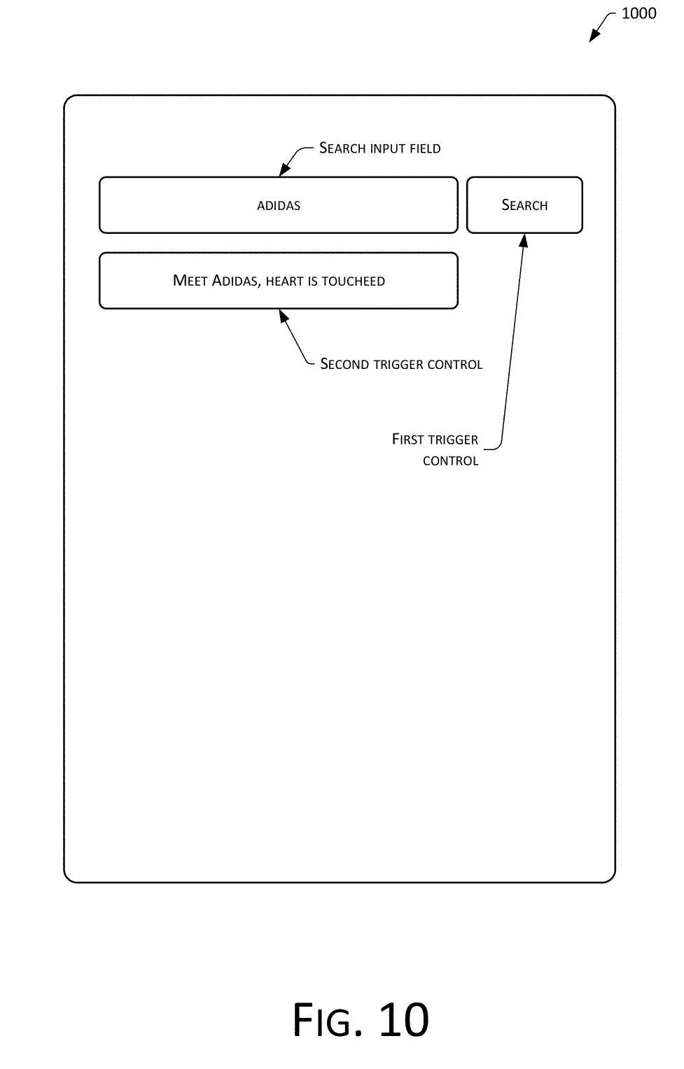

In implementations, the prompt term can be directly presented on the page as the prompt information. The keyword and the prompt term may also be combined and treated as the prompt information. Specifically, the inputted keyword may be “Adidas”, and the prompt term is determined as “meet”+keyword+“, heart is touched”, for example. In this case, the prompt information may be “meet Adidas, heart is touched”, as shown in a page 1000 of FIG. 10.

S808 presents search results for the keyword after a triggering event targeted at the prompt information occurs.

In implementations, the triggering event targeted at the prompt information may include a clicking event occurred for the prompt information; or a predefined gesture operation. The gesture operation is considered to be the triggering event targeted at the prompt information after being recognized by the client terminal. The gesture operation may include a touch trajectory on a touch screen. Alternatively, a predefined state of motion detected by the client terminal via a gyroscope or an accelerometer may be considered to be the triggering event targeted at the prompt information. An example includes shaking a mobile phone by the user.

By generating prompt information in a search page, the present embodiment of the present disclosure can achieve a certain amount of guidance effect for browsing and accesses by a user. Therefore, distribution of accesses on a page end can be implemented. Furthermore, guiding accesses to a business function can be achieved though prompt information, thus facilitating promotion of the business function.

In implementations, the search page further includes a first trigger control. The first trigger control is directed to a first search strategy.

In implementations, the first search strategy may be to perform a search in object information of a website platform based on the keyword, and to return an object result set. Object information in the object result set is displayed via the client terminal. Specifically, the user enters “roller skates” in the input field, for example. Based on this keyword, a list of products related to “roller skates” is found from the object information of the website platform.

In implementations, the first trigger control being directed to the first search strategy can be understood as performing a search using the first search strategy after the client terminal sends the keyword to the server in response to an occurrence of a clicking event associated with the first trigger control.

In other implementations, the first search strategy is set as a default strategy. As such, the first trigger control is not needed to be set. After the keyword is entered, the first search strategy is automatically triggered and invoked to perform other operations of the present solution.

In implementations, a method of providing the first trigger control includes at least one of: setting up a control in the search page, the control being used as a container for terms recommended in the search page. Alternatively, the first trigger control is a button control in an input method that is provided when the input field is selected. A control used for initiating a voice input is provided in the search page. A control used for initiating an image/video input is provided in the search page.

In implementations, the search page may be configured with a text control or a button control, etc., which is used as a container for recommended terms. Alternatively, when the user inputs a keyword into the input field via an input method, the input method can provide the first trigger control, for example, a “return” button. Alternatively, a “search” button may be directly provided in the input method. Alternatively, a control for initiating a voice input function is provided in the search page. Voice inputted by the user can be received when the button is pressed, and releasing the button may represent that voice recording is ended. Furthermore, releasing the button can be regarded as the triggering event, and a search for an inputted keyword is performed according to the first search strategy. Apparently, after the button is released, recognition may be performed for the recorded voice, and a text that is recognized is used as a keyword. Similarly, image/video input is initiated in a manner similar to the voice input, and can be referenced to the above description.

In implementations, when a clicking event for the first trigger control occurs, the page that provides the search result includes an object information list. In implementations, with reference to FIG. 4, after a clicking event for the first trigger control occurs, the page presents the search result for the keyword. The search result includes an object list. For example, the keyword that is presented is “roller skates”, and the search result for “roller skates” is presented, as shown in FIG. 4.

In implementations, the prompt information is located at a second trigger control. The second trigger control is directed to a second search strategy. The first search strategy and the second search strategy are different.

In implementations, the search page can provide a second trigger control. A form of the second trigger control may be a text control or a button control, etc. Apparently, the second control may also be other controls that can provide information display function, and is not described in detail herein.

In implementations, the prompt information is presented on the second trigger control. By monitoring an operation of the user with respect to the second trigger control, a determination can be made as to whether a triggering event caused by this operation is aimed at the prompt information. Presenting the prompt information on the second trigger control can mean a text of the prompt information being a part of the second trigger control. Furthermore, the text of the prompt information can be a property value of a display property of the second trigger control.

In other implementations, a position of the prompt information may include at least one of a background of the input field, an activation page, an item in a pull-down menu, in navigation hot recommendation, or in a classified navigation bar.

In implementations, the triggering event includes the second trigger control being clicked. The operation of presenting the search result for the keyword includes presenting a search result that obtained for the keyword according to the second search strategy.

In implementations, the second trigger control is directed to the second search strategy. When a clicking event occurs for the second trigger control, the client terminal sends the keyword to the server. The server performs a search according to the second search strategy and returns a search result. The second search strategy is different from the first search strategy. For a same keyword, a search result obtained using the first search strategy may be different from a result obtained using the second search strategy.

In implementations, the search result that is returned based on the second search strategy may include topic information and aggregate information that matches with the keyword, or topic information, aggregate information and object information that matches with the keyword, or aggregate information and historical browsing information that matches with the keyword.

In implementations, the second search strategy may include at least one of the performing a search for a keyword using the content search engine and returning a content result set, and performing a search for the keyword using the collaborative search engine and returning a collaborative result set. Alternatively, the second search strategy includes at least one of the above methods, and performing a search for the keyword using the object search engine and returning an object result set.

In implementations, when a triggering event directed to the prompt information occurs, presenting a search result for the keyword includes at least one of topic information and aggregate information that matches with the keyword. Alternatively, the search result includes object information, and at least one of topic information and aggregate information that matches with the keyword.

Referring to FIG. 5, in implementations, a keyword may be provided to the content search engine, so that topic information and/or aggregate information can be provided. The keyword may be provided to the collaborative search engine. Object information that has been browsed in the past can be provided through a collaborative result set returned by the collaborative search engine. The keyword may be provided to the object search engine, so that object information that is found can be provided.

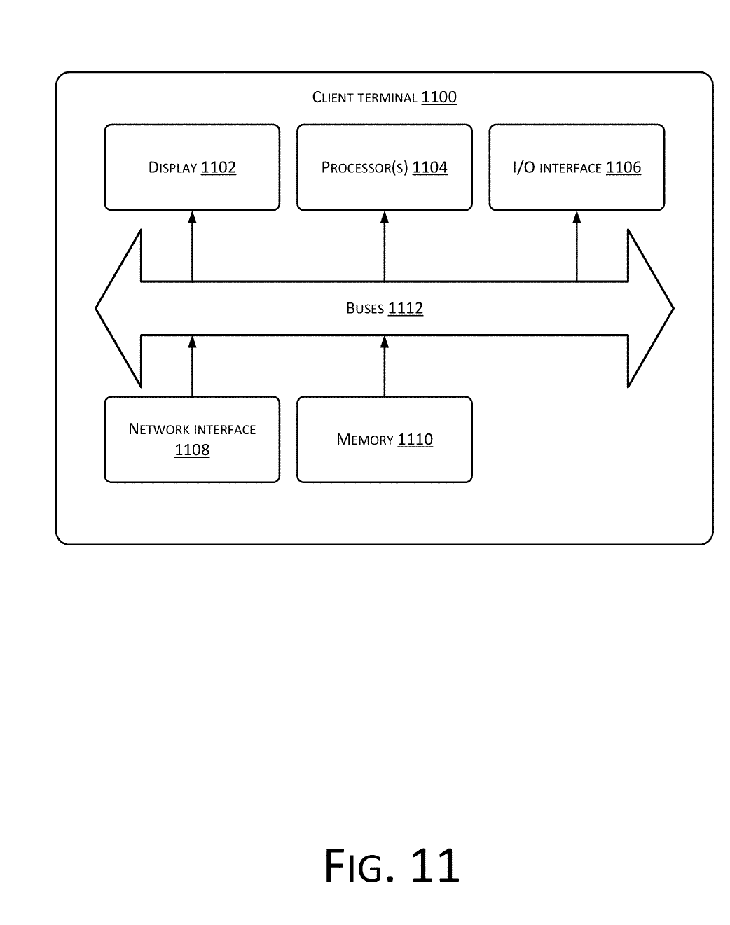

Referring to FIG. 11, the present disclosure further provides a client terminal 1100. The client terminal 1100 may include a display 1102, one or more processor(s) 1104, an input/output interface 1106, a network interface 1108, memory 1110, and buses 1112. The memory may be a form of a computer-readable media as describing in the foregoing embodiments.

The processor(s) 1104 is used for controlling the display to present a search page, the search page including a keyword input field; receiving a keyword inputted by a user in the input field; and controlling the display 1102 to present prompt information, the prompt information being generated based on the keyword, and to present a search result of the keyword in response to an occurrence of a triggering event directed to the prompt information.

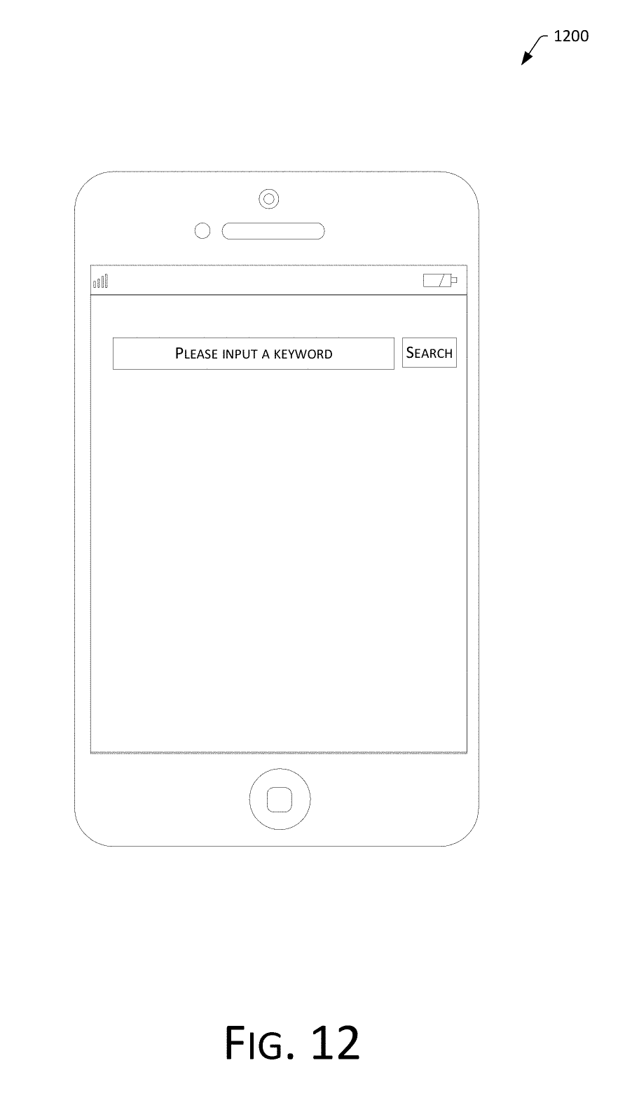

Referring to FIG. 12, in implementations, the display of the client terminal may present a search page. Specifically, an interface displayed by the display provides a search input field for receiving a keyword entered by a user, for example.

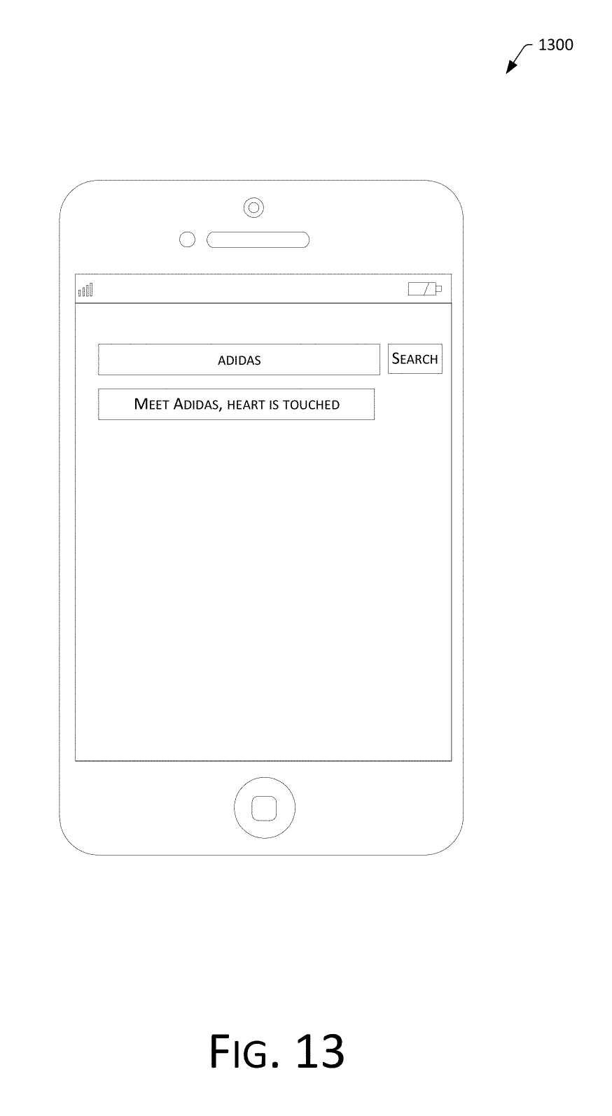

Referring to FIG. 13, in implementations, the client terminal may have rule(s) of generating prompt information. After the keyword is inputted into the input field, prompt information is generated according to the rule(s) of generating prompt information. Specifically, the rule(s) of generating prompt information may include correspondingly storing prompt index terms and prompt terms. In response to receiving the keyword, the client terminal performs a matching of the keyword in the prompt index terms, obtains a prompt index term corresponding to the keyword, and thereby determines a prompt term corresponding to the prompt index term. Apparently, the rule(s) of generating prompt information may also include predefined categories and corresponding prompt terms. For an inputted keyword, a determination is made as to which category the keyword belongs to, and a prompt term of an associated predefined category is read. The predefined categories may include brand name terms, product categories, etc. Apparently, after receiving the keyword, the client terminal can provide the keyword to a server, and the server generates prompt information which is sent to the client terminal via a network.

In implementations, the prompt term can be directly presented on the page as the prompt information. The keyword and the prompt term may also be combined and treated as the prompt information. Specifically, the inputted keyword may be “Adidas”, and the prompt term is determined as “meet”+keyword+“, heart is touched”, for example. In this case, the prompt information may be “meet Adidas, heart is touched”.

In implementations, a triggering event targeted at the prompt information may include a clicking event occurred for the prompt information; or a predefined gesture operation. The gesture operation is considered to be the triggering event targeted at the prompt information after being recognized by the client terminal. The gesture operation may include a touch trajectory on a touch screen. Alternatively, a predefined state of motion detected by the client terminal via a gyroscope or an accelerometer may be considered to be the triggering event targeted at the prompt information. An example includes shaking a mobile phone by the user.

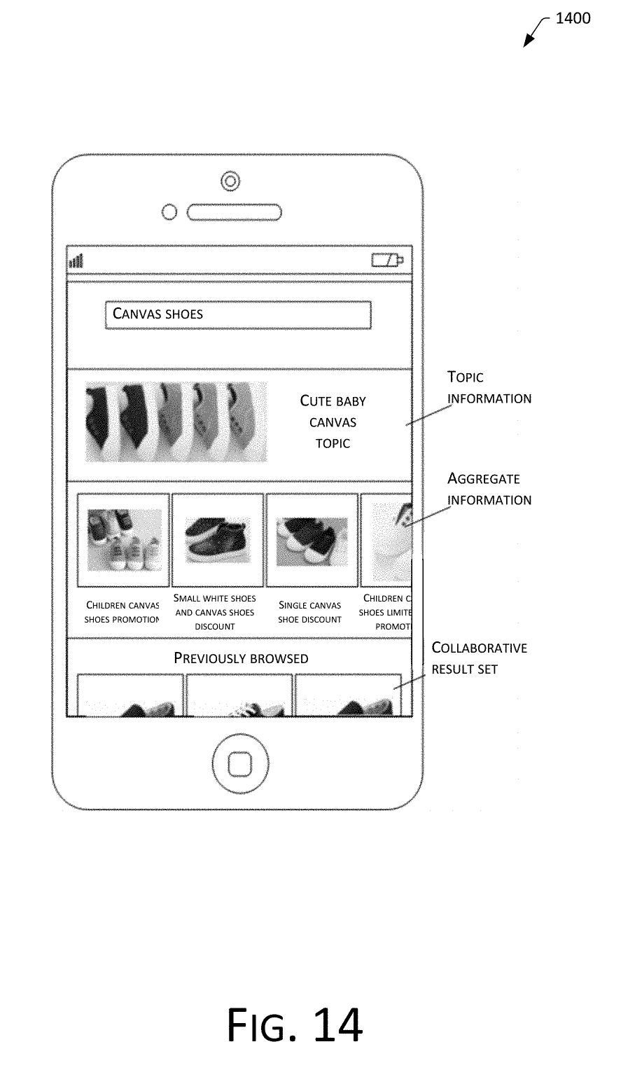

Referring to FIG. 14, in implementations, the client terminal responds to the triggering event associated with the prompt information, and displays a search result page. The page uses “canvas shoes” as an example of the keyword. The displayed result page can include topic information and aggregate information in a content result set, and object information in a collaborative result set.

Specific functions implemented by the client terminal 1100, the processor(s) 1104 and the display 1102 thereof, which are disclosed in the foregoing embodiments, can be referenced and compared to the previous embodiments of the present disclosure.

The processor(s) 1104 can be implemented in any suitable form. For example, a processor can use, for example, a microprocessor or a processor, and computer-readable media that stores computer-readable program code (such as software or firmware) executable by the (micro) processor, a logic gate, a switch, an Application Specific Integrated Circuit (ASIC), a programmable logic controller, an embedded controller, etc.

The display 1102 can be a display tool that displays a particular electronic file onto a screen via a specific transmission device, and reflects thereof into a human eye. The display may include a liquid crystal display (LCD), a cathode ray tube (CRT) display, a light emitting diode (LED) display, etc.

As can be seen from the technical solutions provided by the embodiments of the present disclosure, the embodiments of the present disclosure provide a content search engine, a collaborative search engine and an object search engine. Through any combinations of the above search engines, a diversity of search strategies can be achieved and conducted for a keyword provided by a client terminal, and information having multiple dimensions can be provided to a user. The user can obtain an entry for topic information, an entry for aggregate information such as promotion, an entry for a collaborative result set related to a browsing history or a favorite history, and a product information list, in a page. Therefore, operations of the user are simplified, and the user can understand information related to the keyword in a comprehensive manner, thus providing convenience to the user and improving user experience.

In 1900s, an improvement in a technology can be clearly distinguished as a hardware improvement (an improvement in a circuit structure such as a diode, a transistor, a switch, etc.) or a software improvement (for an improvement in a method procedure). However, along with the development of the technology, improvements in a number of existing method procedures can be seen as direct improvements in circuit structures of hardware. Design engineers program processes of improved methods into hardware circuits to obtain corresponding hardware circuit structure in most of the time. Therefore, it cannot be said that an improvement in a process of a method cannot be implemented using a hardware entity module. For example, a Programmable Logic Device, PLD (such as Field Programmable Gate Array, FPGA) is such an integrated circuit, logic functions thereof being determined by a user through device programming. A design engineer programs a digital system to be integrated in a PLD himself/herself, without the need of a chip manufacturer to design and manufacture a specialized integrated circuit chip2. Moreover, this type of programming replaces manually making integrated circuit chip, and mostly employs “logic compiler” software for implementation. This is similar to software complier used when programs are developed and compiled. Original codes before compiling are also written using a specialized programming language, which is called as Hardware Description Language (HDL). There are a number of different types of HDL, rather than one type. Examples include ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. The most commonly used one is VHDL (Very-High-Speed Integrated Circuit Hardware Description Language) and Verilog2. One skilled in the art can understand that a hardware circuit of a logical process of a method can be easily be implemented only through logic programming to program the process of the method using the above hardware description languages into an integrated circuit.

One skilled in the art should also understand that, other than implementing a controller purely through computer-readable programming codes, logic programming of method operations can be used to allow the controller to implement the same functions in a form of logic gates, switches, specialized integrated circuits, programmable logic controllers, and embedded microcontrollers, etc. Therefore, this type of controller can be considered as a hardware component, and an apparatus included therein that is used for implementing various functions is also considered as an internal structure of the hardware component. Alternatively, the apparatus included therein that is used for implementing various functions can be considered as a software module that implements the method or an internal structure of a hardware component.

As can be seen from the description of the foregoing embodiments, one skill in the art can clearly understand that the present disclosure can be implemented in a form of a software component with a necessary hardware platform. Based on this understanding, the essence of the technical solutions of the present disclosure or the portions that provide contributions to the existing technologies can be implemented in a form of a software product. This computer software product may be stored in storage media, such as ROM/RAM, a magnetic disk, an optical disk, etc., and includes instructions used for driving a computing device (which can be a personal computer, a server, or a networked device, etc.) to perform the method described in the embodiments or portions of the embodiments of the present disclosure.

The embodiments of the present disclosure are described in a progressive manner. The same or similar portions of the embodiments can be referenced with each other. Each embodiment places an emphasis differently from other embodiments. For the embodiments of the client terminal, references can be made with respect to description of the foregoing method embodiments for comparison and explanation.

The present disclosure can be described in the context of computer-executable instructions executed by a computer, such as a program module. Generally, a program module includes a routine, a program, an object, a component, a data structure, etc., that performs a designated task or implements a designated abstract object type. The present disclosure can also be implemented in distributed computing environments. In these distributed computing environments, a remote processing device that is connected via a network can perform tasks. In a distributed computing environment, a program module can be located in local and remote computer-storage media including a storage device.

Although the present disclosure is described using the embodiments, one of ordinary skill in the art understands that the present disclosure has a number of variations and changes without departing the spirit of the present disclosure. The appended claims are intended to include these variations and changes without departing the spirit of the present disclosure.

The present disclosure may be further understood with clauses as follows.

Clause 1: A system comprising: one or more processors; memory; a front-end server stored in the memory and executable by the one or more processors to receive a keyword provided by a client terminal, provide the keyword to the content search engine, and return a content result set that is obtained to the client terminal; and a content search engine stored in the memory and executable by the one or more processors to perform a search in a content resource pool based on the keyword to obtain the content result set, and provide the content result set to the front-end server, wherein the content resource pool includes at least one of pieces of topic information or aggregate information of objects, and the content result set includes a piece of the topic information and/or a piece of the aggregate information that matches the keyword.

Clause 2: The system of Clause 1, further comprising: a collaborative search engine stored in the memory and executable by the one or more processors to obtain access data of the client terminal, perform a search in the access data using the keyword to obtain a collaborative result set, and return the collaborative result set to the front-end server, the collaborative search set including object information that matches with the keyword in the access data, wherein the front-end server is further used for providing the keyword to the collaborative search engine and providing the collaborative result set that is obtained to the client terminal.

Clause 3: The system of Clause 2, wherein the front-end server divides the collaborative result set into at least one collaborative result subset and assigns the collaborative result subset with a display position in the client terminal, when returning the content result set and the collaborative result set to the client terminal.

Clause 4: The system of Clause 2, wherein the content result set ranks higher than the collaborative result set when the front-end server returns the content result set and the collaborative result set to the client terminal.

Clause 5: The system of Clause 1, wherein a page pointed by the piece of topic information include a description page of performance of the object, a shopping guide page of the object, an evaluation page of the object, or a detailed page including description information of the object.

Clause 6: The system of Clause 1, wherein a page pointed by the piece of aggregate information include a data set obtained by collecting object information of objects having identical or similar attribute objects from among a same type of objects of a website platform.

Clause 7: The system of Clause 1, wherein the content resource pool stores object information corresponding to the piece of topic information or the piece of aggregate information, the object information being used for matching with the keyword provided by the client terminal to determine whether the piece of topic information or the piece of aggregate information matches the keyword.

Clause 8: The system of Clause 1, wherein the pieces of aggregate information of the content resource pool are updated from a website platform after a predefined time interval.

Clause 9: The system of claim 1, wherein the pieces of topic information have specific life cycles, wherein a particular piece of topic information of which a respective life cycle is past is not to be matched with the keyword provided by the client terminal.

Clause 10: The system of Clause 1, further comprising an object search engine stored in the memory and executable by the one or more processors to perform a search in an object resource pool using the keyword to obtain an object result set, and provide the object result set to the front-end server, the object resource pool include at least one piece of object information, wherein the front-end server is further configured to provide the keyword to the object search engine, and provide the object result set that is obtained to the client terminal.

Clause 11: The system of Clause 10, wherein the object resource pool is generated by: obtaining an object information pool by conducting a selection from among a website platform, the object information pool including at least one piece of object information; obtaining a first list of object having question-and-answer content, a second list of objects having recommendation reasons, and a third list of objects reaching particular rating levels, from the website platform; matching the object information pool according to an order from the first list of objects, the second list of objects, to the third list of objects, to obtain recommendation information of at least a portion of the object information in the object information pool, wherein a piece of question-and-answer content, a recommendation reason or a particular rating level that matches the object information in the object information pool is taken as the recommendation information; and forming the object resource pool from the recommendation information and the object information pool.

Clause 12: The system of Clause 1, wherein the front-end server modifies the keyword when an amount of data in a search result set that is found for the keyword provided by the client terminal, and invokes the content search engine based on the modified keyword to obtain a new content result set.

Clause 13: The system of Clause 12, wherein the keyword is modified by reducing a number of keywords in a situation that more than two keywords are provided by the client terminal.

Clause 14: The system of Clause 1, wherein the front-end server extracts a specific semantic term from the keyword provided by the client terminal, and provides the specific semantic term to the content search engine for conducting a search, wherein the specific semantic term includes a category term or a brand name term.

Clause 15: The system of Clause 1, wherein the keyword provided by the client terminal includes a plurality of keywords, and the front-end server invokes the content search engine to perform a search using various combinations of a portion of the plurality of keywords, and returns content result sets that are found for the combinations to the client terminal.

Clause 16: A system comprising: one or more processors; memory; a front-end server stored in the memory and executable by the one or more processors to receive a keyword provided by a client terminal, provide the keyword to the content search engine and the object search engine, and return a content result set and an object result set to the client terminal; a content search engine stored in the memory and executable by the one or more processors to search the keyword in a content resource pool to obtain the content result set, provide the content result set to the front-end server, wherein the content resource pool includes at least one of pieces of topic information and aggregate information of objects, and the content result set includes a piece of topic information and/or a piece of aggregate information that matches the keyword; and an object search engine stored in the memory and executable by the one or more processors to perform a search in an object resource pool based on the keyword to obtain the object result set, and provide the object result set to the front-end server, wherein the object resource pool includes at least one piece of object information.

Clause 17: The system of Clause 16, wherein a page pointed by the piece of topic information include a description page of performance of the object, a shopping guide page of the object, an evaluation page of the object, or a detailed page including description information of the object.

Clause 18: The system of Clause 16, wherein a page pointed by the piece of aggregate information include a data set obtained by collecting object information of objects having identical or similar attribute objects from among a same type of objects of a website platform.

Clause 19: The system of Clause 16, wherein the content resource pool stores object information corresponding to the piece of topic information or the piece of aggregate information, the object information being used for matching with the keyword provided by the client terminal to determine whether the piece of topic information or the piece of aggregate information matches the keyword.

Clause 20: The system of Clause 16, wherein the pieces of aggregate information of the content resource pool are updated from a website platform after a predefined time interval.

Clause 21: The system of Clause 16, wherein the pieces of topic information have specific life cycles, wherein a particular piece of topic information of which a respective life cycle is past is not to be matched with the keyword provided by the client terminal.

Clause 22: The system of Clause 16, wherein the object resource pool is generated by: obtaining an object information pool by conducting a selection from among a website platform, the object information pool including at least one piece of object information; obtaining a first list of object having question-and-answer content, a second list of objects having recommendation reasons, and a third list of objects reaching particular rating levels, from the website platform; matching the object information pool according to an order from the first list of objects, the second list of objects, to the third list of objects, to obtain recommendation information of at least a portion of the object information in the object information pool, wherein a piece of question-and-answer content, a recommendation reason or a particular rating level that matches the object information in the object information pool is taken as the recommendation information; and forming the object resource pool from the recommendation information and the object information pool.

Clause 23: The system of Clause 16, wherein the front-end server modifies the keyword when an amount of data in a search result set that is found for the keyword provided by the client terminal, and invokes the content search engine and the object search engine based on the modified keyword to obtain a new content result set and a new object result set.

Clause 24: The system of Clause 16, wherein the keyword is modified by reducing a number of keywords in a situation that more than two keywords are provided by the client terminal.

Clause 25: The system of Clause 16, wherein the front-end server extracts a specific semantic term from the keyword provided by the client terminal, and provides the specific semantic term to the content search engine and the object search engine for conducting searches, wherein the specific semantic term includes a category term or a brand name term.

Clause 26: The system of claim 16, wherein the keyword provided by the client terminal includes a plurality of keywords, and the front-end server invokes the content search engine and the object search engine to perform a search using various combinations of a portion of the plurality of keywords, and returns content result sets and object result sets that are found for the combinations to the client terminal.

Clause 27: A system comprising: one or more processors; memory; a front-end server stored in the memory and executable by the one or more processors to receive a keyword provided by a client terminal, provide the keyword to the collaborative search engine and the object search engine, and return a collaborative result set and an object result set that are obtained to the client terminal; a collaborative search engine stored in the memory and executable by the one or more processors to obtain access data of the client terminal, search the keyword in the access data to obtain the collaborative result set, and return the collaborative result set to the front-end server, wherein the collaborative result set includes object information that matches with the keyword in the access data; and an object search engine stored in the memory and executable by the one or more processors to perform a search in an object resource pool based on the keyword to obtain the object result set, and provide the object result set to the front-end server, wherein the object resource pool includes at least one piece of object information.

Clause 28: The system of Clause 27, wherein the front-end server divides the collaborative result set into at least one collaborative result subset and assigns a display position in the client terminal to the collaborative result subset, when returning the collaborative result set to the client terminal.

Clause 29: The system of Clause 27, wherein the object resource pool is generated by: obtaining an object information pool by conducting a selection from among a website platform, the object information pool including at least one piece of object information; obtaining a first list of object having question-and-answer content, a second list of objects having recommendation reasons, and a third list of objects reaching particular rating levels, from the website platform; matching the object information pool according to an order from the first list of objects, the second list of objects, to the third list of objects, to obtain recommendation information of at least a portion of the object information in the object information pool, wherein a piece of question-and-answer content, a recommendation reason or a particular rating level that matches the object information in the object information pool is taken as the recommendation information; and forming the object resource pool from the recommendation information and the object information pool.

Clause 30: The system of Clause 27, wherein the front-end server modifies the keyword when an amount of data in a search result set that is found for the keyword provided by the client terminal, and invokes the collaborative search engine and the object search engine based on the modified keyword to obtain a new collaborative result set and a new object result set.

Clause 31: The system of Clause 30, wherein the keyword is modified by reducing a number of keywords in a situation that more than two keywords are provided by the client terminal.

Clause 32: The system of Clause 27, wherein the front-end server extracts a specific semantic term from the keyword provided by the client terminal, and provides the specific semantic term to the collaborative search engine and the object search engine for conducting searches, wherein the specific semantic term includes a category term or a brand name term.

Clause 33: The system of Clause 27, wherein the keyword provided by the client terminal includes a plurality of keywords, and the front-end server invokes the collaborative search engine and the object search engine to perform a search using various combinations of a portion of the plurality of keywords, and returns collaborative result sets and object result sets that are found for the combinations to the client terminal.

Clause 34: A method implemented by a client terminal, the method comprising: displaying a search page, the search page including a keyword input field; receiving a keyword in the input field that is inputted by a user; displaying prompt information, the prompt information being generated based on the keyword; and displaying a search result for the keyword in response to an occurrence of a triggering event directed to the prompt information.

Clause 35: The method of Clause 34, wherein the search page further includes a first trigger control, the first trigger control being directed to a first search strategy.

Clause 36: The method of Clause 35, further comprising providing the first trigger control by setting the control in the search page, the control acting as a container for recommended terms in the search page, wherein the first trigger control is a button control provided in an input method when the input field is selected, a control used for initiating a voice input provided in the search page, or a control used for initiating an image input provided in the search page.

Clause 37: The method of Clause 35, wherein a search result page provided when a triggering event associated with the first trigger control occurs includes a list of object information.

Clause 38: The method of Clause 35, wherein the prompt information is located at a second trigger control, the second trigger control being directed to a second search strategy, and the first search strategy and the second search strategy are different.

Clause 39: The method of Clause 38, wherein the triggering event includes the second trigger control being clicked, and displaying the search result for the keyword comprises displaying a search result that is obtained for the keyword based on the second search strategy.

Clause 40: The method of Clause 34, wherein displaying the search result for the keyword in response to the occurrence of the triggering event directed to the prompt information comprises at least one of topic information and aggregate information that matches with the keyword, or the search result includes at least one of the topic information and aggregate information or object information.

Clause 41: A client terminal comprising: a display; and one or more processors used for controlling the display to present a search page, the search page including a keyword input field, receiving a keyword inputted by a user in the input field; controlling the display to present prompt information, the prompt information being generated based on the keyword, and to present a search result of the keyword in response to an occurrence of a triggering event directed to the prompt information.

What is claimed is:

1. A system comprising:
one or more processors;
memory;
a front-end server stored in the memory and executable by the one or more processors to:
receive a keyword provided by a client terminal,
provide the keyword to the content search engine, and
return a content result set that is obtained to the client terminal; and
a content search engine stored in the memory and executable by the one or more processors to:
perform a search in a content resource pool based on the keyword to obtain the content result set, and
provide the content result set to the front-end server, wherein the content resource pool includes at least one of pieces of topic information or aggregate information of objects, and the content result set includes a piece of the topic information and/or a piece of the aggregate information that matches the keyword.

2. The system of claim 1, further comprising:
a collaborative search engine stored in the memory and executable by the one or more processors to:
obtain access data of the client terminal,
perform a search in the access data using the keyword to obtain a collaborative result set, and
return the collaborative result set to the front-end server, the collaborative search set including object information that matches with the keyword in the access data, wherein the front-end server is further used for providing the keyword to the collaborative search engine and providing the collaborative result set that is obtained to the client terminal.

3. The system of claim 2, wherein the front-end server divides the collaborative result set into at least one collaborative result subset and assigns the collaborative result subset with a display position in the client terminal, when returning the content result set and the collaborative result set to the client terminal.

4. The system of claim 1, wherein the content resource pool stores object information corresponding to the piece of topic information or the piece of aggregate information, the object information being used for matching with the keyword provided by the client terminal to determine whether the piece of topic information or the piece of aggregate information matches the keyword.

5. The system of claim 1, wherein the pieces of topic information have specific life cycles, wherein a particular piece of topic information of which a respective life cycle is past is not to be matched with the keyword provided by the client terminal.

6. The system of claim 1, further comprising an object search engine stored in the memory and executable by the one or more processors to perform a search in an object resource pool using the keyword to obtain an object result set, and provide the object result set to the front-end server, the object resource pool include at least one piece of object information, wherein the front-end server is further configured to provide the keyword to the object search engine, and provide the object result set that is obtained to the client terminal.

7. The system of claim 6, wherein the object resource pool is generated by:
obtaining an object information pool by conducting a selection from among a website platform, the object information pool including at least one piece of object information;
obtaining a first list of object having question-and-answer content, a second list of objects having recommendation reasons, and a third list of objects reaching particular rating levels, from the website platform;
matching the object information pool according to an order from the first list of objects, the second list of objects, to the third list of objects, to obtain recommendation information of at least a portion of the object information in the object information pool, wherein a piece of question-and-answer content, a recommendation reason or a particular rating level that matches the object information in the object information pool is taken as the recommendation information; and
forming the object resource pool from the recommendation information and the object information pool.

8. A method comprising:
receiving a keyword provided by a client terminal,
searching the keyword in a content resource pool to obtain a content result set, the content resource pool including at least one of pieces of topic information and aggregate information of objects, and the content result set including a piece of topic information and/or a piece of aggregate information that matches the keyword;
performing a search in an object resource pool based on the keyword to obtain a object result set, the object resource pool including at least one piece of object information; and
returning the content result set and the object result set to the client terminal.

9. The method of claim 8, further comprising generating the object resource pool by:
obtaining an object information pool by conducting a selection from among a website platform, the object information pool including at least one piece of object information;
obtaining a first list of object having question-and-answer content, a second list of objects having recommendation reasons, and a third list of objects reaching particular rating levels, from the website platform;
matching the object information pool according to an order from the first list of objects, the second list of objects, to the third list of objects, to obtain recommendation information of at least a portion of the object information in the object information pool, wherein a piece of question-and-answer content, a recommendation reason or a particular rating level that matches the object information in the object information pool is taken as the recommendation information; and
forming the object resource pool from the recommendation information and the object information pool.

10. The method of claim 8, further comprising:
extracting a specific semantic term from the keyword provided by the client terminal, the specific semantic term including a category term or a brand name term; and
conducting searches using the specific semantic term.

11. The method of claim 8, wherein the keyword provided by the client terminal includes a plurality of keywords, and the method further comprises: performing searches using various combinations of a portion of the plurality of keywords, and returning content result sets and object result sets that are found for the combinations to the client terminal.

12. The method of claim 8, further comprising:
obtaining access data of the client terminal,
searching the keyword in the access data to obtain a collaborative result set, the collaborative result set including object information that matches with the keyword in the access data; and
returning the collaborative result set to the client terminal.

13. One or more computer-readable media storing executable instructions that, when executed by one or more processors, cause the one or more processors to perform acts comprising:
displaying a search page, the search page including a keyword input field;
receiving a keyword in the input field that is inputted by a user;
displaying prompt information, the prompt information being generated based on the keyword; and
displaying a search result for the keyword in response to an occurrence of a triggering event directed to the prompt information.

14. The one or more computer-readable media of claim 13, wherein the search page further includes a first trigger control, the first trigger control being directed to a first search strategy, wherein the acts further comprise providing the first trigger control by setting the control in the search page, the control acting as a container for recommended terms in the search page, wherein the first trigger control is a button control provided in an input method when the input field is selected, a control used for initiating a voice input provided in the search page, or a control used for initiating an image input provided in the search page.

15. The one or more computer-readable media of claim 13, wherein the prompt information is located at a second trigger control, the second trigger control being directed to a second search strategy which is different from the first search strategy, and wherein the triggering event includes the second trigger control being clicked, and displaying the search result for the keyword comprises displaying a search result that is obtained for the keyword based on the second search strategy.

16. A method implemented by a computing device, the method comprising:
displaying a search page, the search page including a keyword input field;
receiving a keyword in the input field that is inputted by a user;
displaying prompt information, the prompt information being generated based on the keyword; and
displaying a search result for the keyword in response to an occurrence of a triggering event directed to the prompt information.

17. The method of claim 16, further comprising providing a first trigger control in the search page by setting a particular control in the search page, the particular control acting as a container for recommended terms in the search page, wherein the first trigger control is a button control provided in an input method when the input field is selected, a control used for initiating a voice input provided in the search page, or a control used for initiating an image input provided in the search page.

18. The method of claim 16, wherein displaying the search result for the keyword in response to the occurrence of the triggering event directed to the prompt information comprises at least one of topic information and aggregate information that matches with the keyword, or the search result includes at least one of the topic information and aggregate information or object information.

19. An apparatus comprising:
a display; and
one or more processors used for controlling the display to present a search page, the search page including a keyword input field, receiving a keyword inputted by a user in the input field; controlling the display to present prompt information, the prompt information being generated based on the keyword, and to present a search result of the keyword in response to an occurrence of a triggering event directed to the prompt information.

20. The apparatus of claim 19, wherein presenting the search result for the keyword in response to the occurrence of the triggering event directed to the prompt information comprises at least one of topic information and aggregate information that matches with the keyword, and the search result includes at least one of the topic information and aggregate information or object information.
